(19) United States
(12) Patent Application Publication
(10) Pub. No.: US 2026/0243666 A1
(43) Pub. Date: Aug. 20, 2026

(54) INTERFEROGRAM-BASED INTELLIGENT SPECTROSCOPY

(71) Applicant: Si-Ware Systems, Cairo (EG)

(72) Inventors: Bassem Mortada, Cairo (EG); Ashar Seif Al-Nasr, Cairo (EG); Yasser M. Sabry, Cairo (EG); Ahmed Fadeel, Cairo (EG); Ahmed Darweesh, Cairo (EG); Samir Abozyd, Tanta (EG)

(21) Appl. No.: 19/545,571

(22) Filed: Feb. 20, 2026

Related U.S. Application Data
(60) Provisional application No. 63/761,013, filed on Feb. 20, 2025.

(51) Int. Cl. G01N 21/35

(52) U.S. Cl. CPC G01N 21/35; G01N 2021/3595

(57) ABSTRACT

Aspects relate to intelligent spectroscopic systems where analytical inference is enabled by the interferogram alone as the minimum required measurement representation. An apparatus can include an interferometer configured to receive input light and to modulate the input light to produce modulated light, a detector configured to receive the modulated light and to produce an output signal based on the modulated light, and a processor configured to process the output signal to produce a raw interferogram signal and further to produce interferogram data based on the raw interferogram signal without Fourier transform of the raw interferogram signal. The apparatus can further include an artificial intelligence engine configured to analyze the interferogram data based on a machine learning model to produce a result.

### PRIORITY CLAIM

This application claims priority to and the benefit of Provisional Application No. 63/761,013, filed in the U.S. Patent and Trademark Office on Feb. 20, 2025, the entire content of which is incorporated herein by reference as if fully set forth below in its entirety and for all applicable purposes.

### TECHNICAL FIELD

The technology discussed below relates generally to analytical interferometry, and in particular to chemometric (machine-learning) based analysis of interferometric measurement data.

### BACKGROUND

In spectral sensing, the interaction between electromagnetic radiation, such as light, and matter is studied. Near-Infrared spectroscopy is a powerful analytical technique, involving the measurement of the interaction between near-infrared light and matter. NIR spectroscopy is widely utilized in various industries, including agriculture, pharmaceuticals, and materials science. It provides valuable insights into the composition and properties of samples by analyzing the absorption, reflection, or transmission of NIR light.

The development of analytical chemistry devices based on infrared spectral sensing devices has progressed quickly in the last decade. With the development in multivariate statistical methods, called chemometrics, qualitative and quantitative material analysis using machine-learning is possible using the infrared spectra. The integration of NIR spectroscopy with chemometrics methods has paved the way for advanced analytical and predictive modeling.

### SUMMARY

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In an example, an apparatus includes an interferometer configured to receive input light and to modulate the input light to produce modulated light, a detector configured to receive the modulated light and to produce an output signal based on the modulated light, and a processor configured to process the output signal to produce a raw interferogram signal and further to produce interferogram data based on the raw interferogram signal. The interferogram data is produced without application of a frequency domain transform to the raw interferogram signal. The apparatus further includes an artificial intelligence engine configured to analyze the interferogram data based on a machine learning model to produce a result.

These and other aspects of the disclosure will become more fully understood upon a review of the detailed description, which follows. Other aspects, features, and examples of the present disclosure will become apparent to those of ordinary skill in the art, upon reviewing the following description of specific, exemplary aspects of the present disclosure in conjunction with the accompanying figures. While features of the present disclosure may be discussed relative to certain examples and figures below, all examples of the present disclosure can include one or more of the features discussed herein. In other words, while one or more examples may be discussed as having certain features, one or more of such features may also be used in accordance with the various examples of the disclosure discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 2 illustrates an example of an apparatus configured for interferogram-based intelligent spectroscopy according to some aspects.

FIG. 1 is a diagram illustrating a spectrometer according to some aspects.

FIG. 3 is a diagram illustrating an example of a spatial interferogram data model construction workflow according to some aspects.

FIG. 4 is a flowchart illustrating an example of a process for analyzing interferogram data based on machine learning according to some aspects.

FIG. 5 illustrates another example of an apparatus configured for interferogram-based intelligent spectroscopy according to some aspects.

FIGS. 6A-6C are diagrams illustrating examples of apparatuses including a MEMS interferometer integrated with an edge AI package according to some aspects.

FIG. 7A is a diagram illustrating an example of a reduced-scan interferogram inference architecture based on selective optical path difference (OPD) windowing to produce cropped interferogram signals according to some aspects.

FIG. 7B is a diagram illustrating examples of cropped interferogram signals according to some aspects.

FIG. 8 is a diagram illustrating another example of an apparatus configured for interferogram-based intelligent spectroscopy according to some aspects.

FIG. 9 is a diagram illustrating examples of an interferogram and corresponding spectrum according to some aspects.

FIG. 10 is a diagram illustrating an example of a model construction process for spectral data according to some aspects.

FIG. 11 is a diagram illustrating an example of model stacking according to some aspects.

FIG. 12 is a diagram illustrating an example of a dual modality stacked model according to some aspects.

FIG. 13 is a flowchart illustrating an example of a process for implementing a dual modality stacked model according to some aspects.

FIG. 14 is a diagram illustrating an example of a dual-domain analytical modeling architecture according to some aspects.

FIG. 15 is a diagram illustrating an example of an apparatus implementing a hybrid edge-computing architecture in which both interferogram-domain and spectral-domain signals are exploited for analytical inference according to some aspects.

FIG. 16 is a diagram illustrating an example of a weighted fusion framework according to some aspects.

FIG. 17 is a flowchart illustrating an example of a process for implementing a dual modality stacked model according to some aspects.

FIG. 18 is a diagram illustrating an example of an apparatus implementing an edge-computing architecture in which both interferogram-domain and spectral-domain signals/derived spectral features are integrated into a unified multi-modal intelligence pipeline according to some aspects.

FIGS. 19A-19C are diagrams illustrating an example of a cross-domain feature generation and selection framework according to some aspects.

FIG. 20 is a diagram illustrating another example of an apparatus configured for interferogram-based intelligent spectroscopy according to some aspects.

FIG. 21 is a diagram that illustrates a dual-mode interferometric intelligence architecture according to some aspects.

FIGS. 22A-22C are diagrams illustrating background calibration of an interferometric measurement according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Within the realm of analytical measurements and machine learning (ML) in the context of Near-Infrared Spectroscopy (NIRS), the traditional approach has relied upon Fourier transform spectral data as the foundation for predictive model construction. Thus, intelligent spectroscopic systems based on machine-learning typically rely on apodizing, converting, and transforming a raw interferogram into the spectral domain as a necessary prerequisite for subsequent analysis (e.g., applying chemometric techniques, such as Partial Least Squares (PLS) regression, to the reconstructed spectrum).

Various aspects of the disclosure relate to exploiting the interferogram in its raw and unfiltered form as a direct physical encoding of light-matter interactions, coherence behaviors, and scan-domain signatures. For example, various aspects can relate to intelligent spectroscopic systems where analytical inference, such as generating predictive, descriptive, or classification outputs, is enabled by the interferogram alone as the minimum required measurement representation. By directly using the interferogram data, the Fourier transform step can be eliminated, which can improve real-time decision making and deployment on out-of-processor edge-computing chips.

In addition, various aspects can optionally involve a multi-modal analysis, where the interferogram functions as an essential anchor modality complemented by secondary data representations, such as Fourier spectra, statistical descriptors, or engineered features. For example, instead of depending solely on a single data format, various aspects can synergistically combine Fourier transform spectral data with spatial interferogram data to construct separate predictive models. Subsequently, a model stacking technique can be applied to seamlessly integrate the two distinct data modalities, resulting in the development of enhanced predictive models characterized by increased robustness. Various aspects can further expand on the dual-modality stacked model by incorporating a weighted fusion model that combines interferogram, spectral data, and derived spectral features.

In some examples, an apparatus can be configured to obtain a measurement of a sample and apply a chemometric analysis of the measurement to produce a result. The result can include, for example, a predictive, descriptive, or classification result. For example, the apparatus can include an interferometer configured to receive input light and to modulate the input light to produce modulated light, a detector configured to receive the modulated light and to produce an output signal based on the modulated light, and a processor configured to process the output signal to produce a raw interferogram signal and further to produce interferogram data based on the raw interferogram signal. In this example, the interferogram data is produced without application of a frequency domain transform to the raw interferogram signal. The apparatus can further include an artificial intelligence engine configured to analyze the interferogram data based on a machine learning model to produce the result.

In some examples, the output signal can include a sample interferogram representing a detector intensity as a function of a scan-domain variable during measurement of a sample, and the result is associated with a property of the sample. For example, the scan-domain variable can include an optical path difference of the in interferometer. In some examples, the processor is further configured to deconvolute a background interferogram from the sample interferogram to produce the raw interferogram signal. In some examples, the artificial intelligence engine is further configured to generate a feedback signal based on at least the interferogram data and the apparatus further includes a controller configured to control, based on the feedback signal, one or more of the interferometer, the detector, the processor, or a light source configured to generate the input light.

In some examples, the interferogram data includes the raw interferogram signal. In other examples, the interferogram data includes a smoothed interferogram signal or an amplitude envelope signal computed from the raw interferogram signal. In other examples, the interferogram data includes at least one feature derived from the amplitude envelope signal. For example, the at least one feature can include one or more statistical features (e.g., mean value, log variance value, standard deviation value, skewness value, or Kurtosis value) and/or one or more temporal features (e.g., temporal range, mean crossing rate, maximum temporal slope, zero crossing rate, or number of peaks). In other examples, the interferogram data may be based on a cropped segment of the raw interferogram signal. In some examples, the machine learning model includes a random forest regression model applied to the at least one feature to produce the result.

In some examples, the processor is further configured to produce secondary data derived from an interferogram obtained during a same measurement or a different measurement as that used to obtain the raw interferogram signal. The artificial intelligence engine can further be configured to combine the secondary data with the interferogram data to produce the result. In some examples, the secondary data includes spectral data associated a spectrum produced based on a Fourier transform of the interferogram. In this example, the machine learning model can include a first machine learning model configured to analyze the interferogram data to produce a first result and a second machine learning model configured to analyze the spectral data to produce a second result. For example, the second machine learning model can include a partial least squared (PLS) regression model. The artificial intelligence engine can further be configured to perform model stacking of the first machine learning model and the second machine learning model to produce a final result. For example, the artificial intelligence engine can be configured to concatenate the first result and the second result to form a concatenated input array and to analyze the concatenated input array based on a meta-learner machine learning model to produce the final result. In some examples, the meta-learner machine learning model can include a linear regression model.

In some examples, the processor is further configured to extract one or more spectral features from the spectrum and the artificial intelligence engine is further configured to analyze the one or more spectral features based on a third machine learning model to produce a third result. For example, the third machine learning model can include a PLS regression model. The artificial intelligence engine can further be configured to produce a final result based on a weighted combination of the first result, the second result, and the third result. For example, the one or more spectral features can include one or more of a spectral centroid, spectral spread, spectral energy, spectral entropy, spectral roll-off, spectral flux, spectral flatness, spectral slope, spectral skewness, or spectral Kurtosis. In some example, the artificial intelligence engine is further configured to apply mutual information (MI)-based feature selection to the one or more spectral features to prioritize the one or more spectral features for the third machine learning model.

FIG. 1 is a diagram illustrating a spectrometer 100 according to some aspects. The spectrometer 100 may be, for example, a Fourier Transform infrared (FTIR) spectrometer. In the example shown in FIG. 1, the spectrometer 100 is a Michelson FTIR interferometer. In other examples, the spectrometer may include an FTIR Fabry-Perot interferometer.

FTIR spectrometers measure a single-beam spectrum (power spectral density (PSD)), where the intensity of the single-beam spectrum is proportional to the power of the radiation reaching the detector. In order to measure the spectrum of a sample, a background PSD (i.e., the single-beam spectrum in absence of a sample) may first be measured (e.g., prior to each sample measurement, periodically, or based on other factors) to compensate for any instrument transfer function(s). The single-beam spectrum of light transmitted, reflected, or trans-reflected from the sample under test (i.e., the sample PSD) may then be measured. The absorbance of the sample may be calculated from the transmittance, reflectance, or trans-reflectance of the sample. For example, the transmission, reflection, or trans-reflection spectrum of the sample may be calculated as the ratio of the PSD of the sample to the background PSD. The absorbance may then be obtained as, for example, −log 10 (sample spectrum).

The interferometer 100 includes a fixed mirror 104, a moveable mirror 106, a beam splitter 110, and a detector 112 (e.g., a photodetector). A light source 102 associated with the spectrometer 100 is configured to emit an input beam and to direct the input beam towards the beam splitter 110. The light source 102 may include, for example, a laser source, one or more wideband thermal radiation sources, or a quantum source with an array of light emitting devices that cover the wavelength range of interest.

The beam splitter 110 is configured to split the input beam into two beams. One beam is reflected off of the fixed mirror 104 back towards the beam splitter 110, while the other beam is reflected off of the moveable mirror 106 back towards the beam splitter 110. The moveable mirror 106 may be coupled to an actuator 108 to displace the movable mirror 106 to the desired position for reflection of the beam. An optical path length difference (OPD) is then created between the reflected beams that is substantially equal to twice the mirror 106 displacement. In some examples, the actuator 108 may include a micro-electro-mechanical systems (MEMS) actuator, a thermal actuator, or other type of actuator.

The reflected beams interfere at the beam splitter 110 to produce an output light beam, allowing the temporal coherence of the light to be measured at each different Optical Path Difference (OPD) offered by the moveable mirror 106. The signal corresponding to the output light beam may be detected and measured by the detector 112 at many discrete positions of the moveable mirror 106 to produce an interferogram. In some examples, the detector 112 may include a detector array or a single pixel detector. The interferogram data versus the OPD may then be input to a processor (not shown, for simplicity). The spectrum may then be retrieved, for example, using a Fourier transform carried out by the processor.

In some examples, the interferometer 100 may be implemented as a MEMS interferometer 100a (e.g., a MEMS chip). The MEMS chip 100a may then be attached to a printed circuit board (PCB) 116 that may include, for example, one or more processors, memory devices, buses, and/or other components. In some examples, the PCB 116 may include a spectral analyzer or other processor configured to receive and process the spectrum to produce spectral data. As used herein, the term MEMS refers to the integration of mechanical elements, sensors, actuators and electronics on a common silicon substrate through microfabrication technology. For example, the microelectronics are typically fabricated using an integrated circuit (IC) process, while the micromechanical components are fabricated using compatible micromachining processes that selectively etch away parts of the silicon wafer or add new structural layers to form the mechanical and electromechanical components. One example of a MEMS element is a micro-optical component having a dielectric or metallized surface working in a reflection or refraction mode. Other examples of MEMS elements include actuators, detector grooves and fiber grooves.

In the example shown in FIG. 1, the MEMS interferometer 100a may include the fixed mirror 104, moveable mirror 106, beam splitter 110, and MEMS actuator 108 for controlling the moveable mirror 106. In addition, the MEMS interferometer 100a may include fibers 114 for directing the input beam towards the beam splitter 110 and the output beam from the beam splitter 110 towards the detector (e.g., detector 112). In some examples, the MEMS interferometer 100a may be fabricated using a Deep Reactive Ion Etching (DRIE) process on a Silicon On Insulator (SOI) wafer in order to produce the micro-optical components and other MEMS elements that are able to process free-space optical beams propagating parallel to the SOI substrate. For example, the electro-mechanical designs may be printed on masks and the masks may be used to pattern the design over the silicon or SOI wafer by photolithography. The patterns may then be etched (e.g., by DRIE) using batch processes, and the resulting chips (e.g., MEMS chip 100a) may be diced and packaged (e.g., attached to the PCB 116).

For example, the beam splitter 110 may be a silicon/air interface beam splitter (e.g., a half-plane beam splitter) positioned at an angle (e.g., 45 degrees) from the input beam. The input beam may then be split into two beams L1 and L2, where L1 propagates in air towards the moveable mirror 106 and L2 propagates in silicon towards the fixed mirror 104. Here, L1 originates from the partial reflection of the input beam from the half-plane beam splitter 110, and thus has a reflection angle equal to the beam incidence angle. L2 originates from the partial transmission of the input beam through the half-plane beam splitter 110 and propagates in silicon at an angle determined by Snell's Law. In some examples, the fixed and moveable mirrors 104 and 106 are metallic mirrors, where selective metallization (e.g., using a shadow mask during a metallization step) is used to protect the beam splitter 110. In other examples, the mirrors 104 and 106 are vertical Bragg mirrors that can be realized using, for example, DRIE.

In some examples, the MEMS actuator 108 may be an electrostatic actuator formed of a comb drive and spring. For example, by applying a voltage to the comb drive, a potential difference results across the actuator 108, which induces a capacitance therein, causing a driving force to be generated as well as a restoring force from the spring, thereby causing a displacement of moveable mirror 106 to the desired position for reflection of the beam back towards the beam splitter 110.

The unique information from the vibrational absorption bands of a molecule is reflected in an infrared spectrum that may be produced, for example, by the spectrometer 100 shown in FIG. 1. By applying spectral numerical processing and statistical analysis to a spectrum, the information in the spectrum may be identified or otherwise classified. The application of statistical methods to the analysis of experimental data is traditionally known as chemometrics, and more recently as artificial intelligence based on machine learning models.

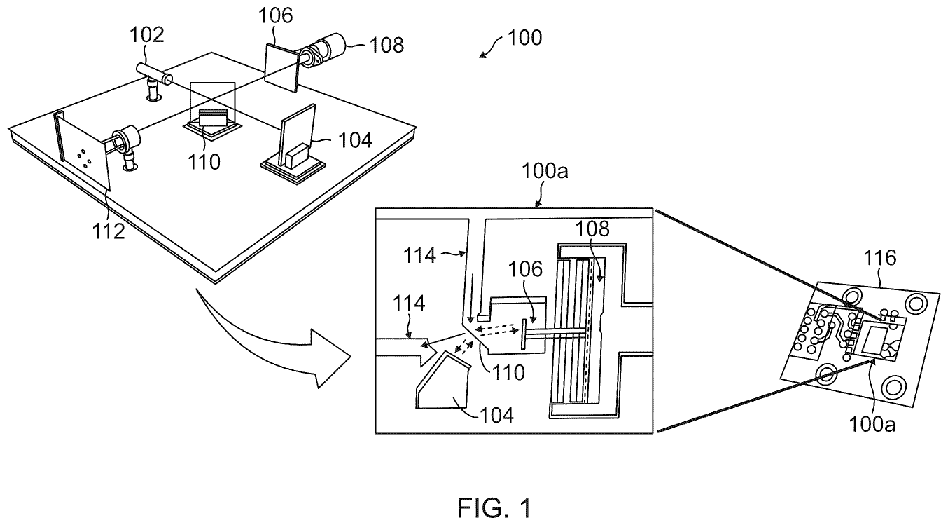

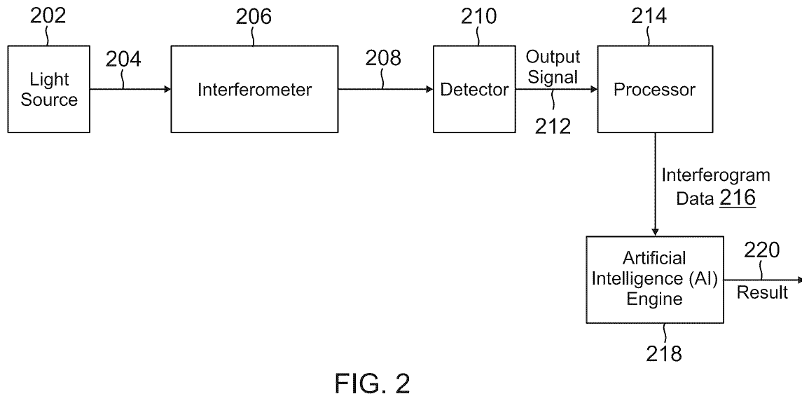

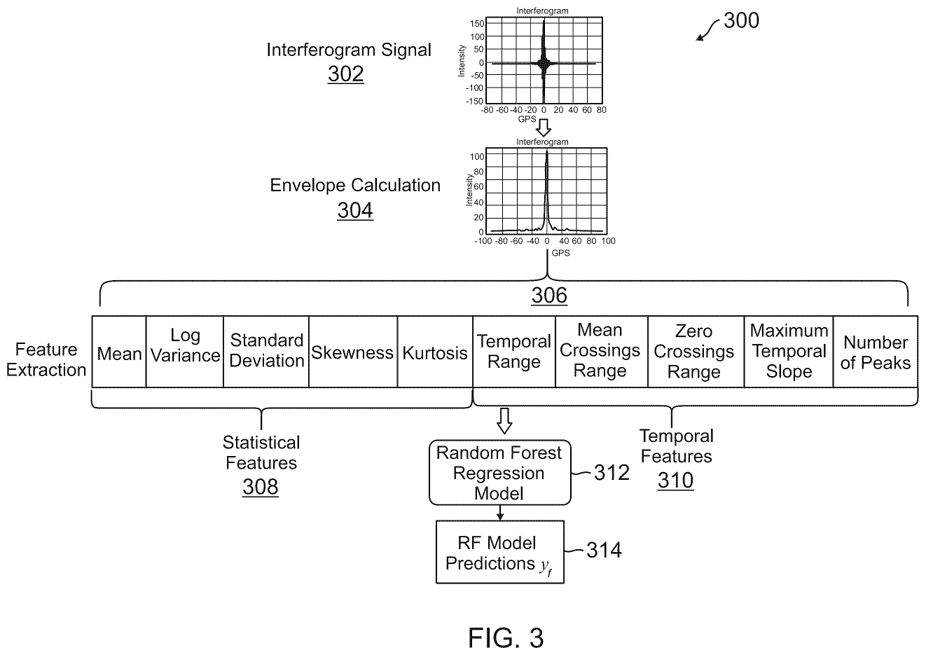

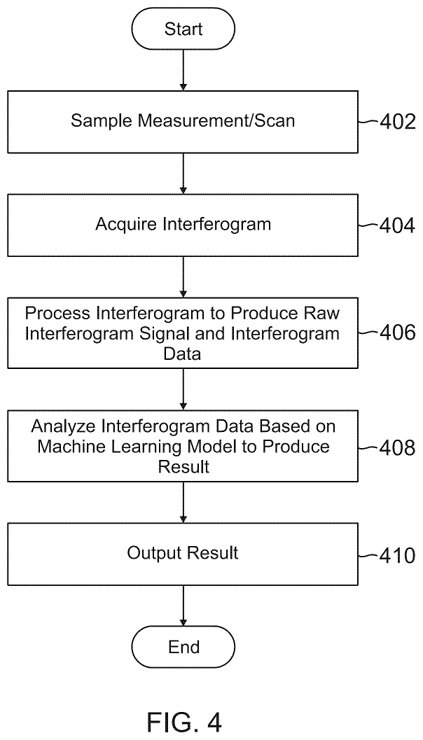

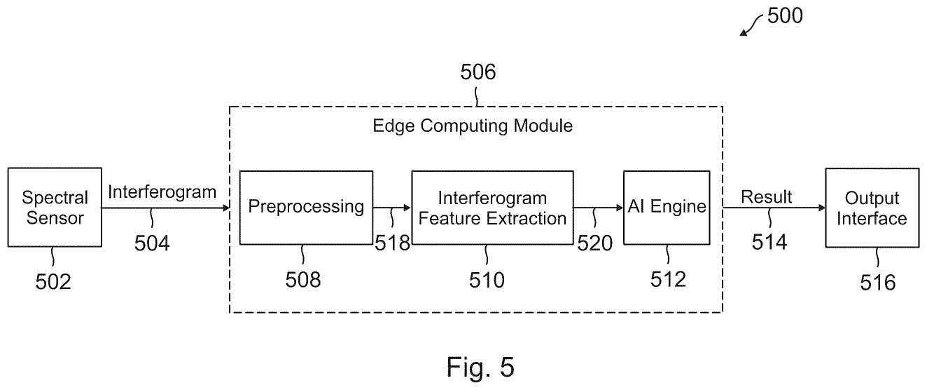

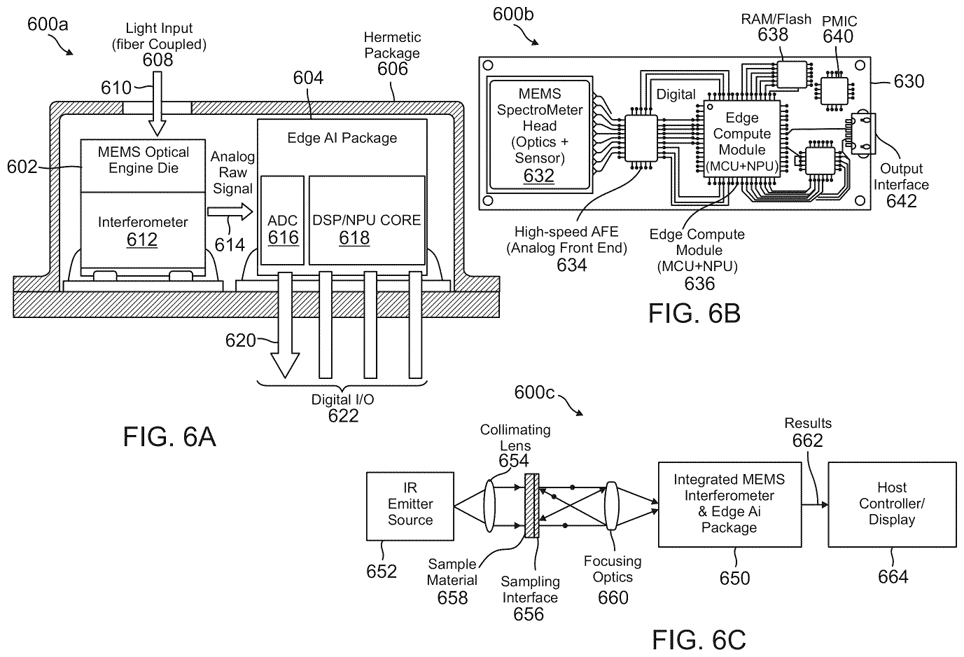

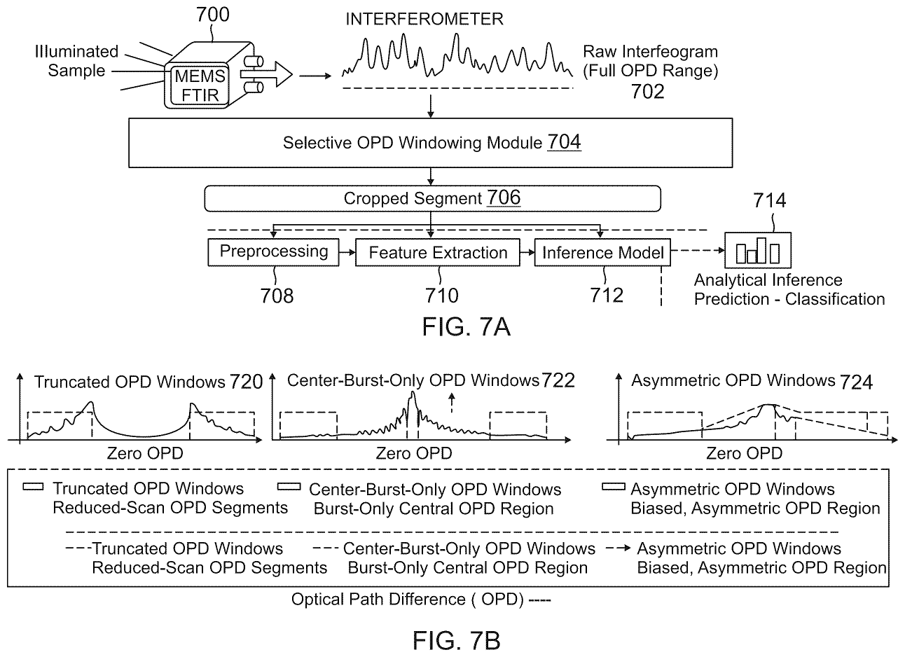

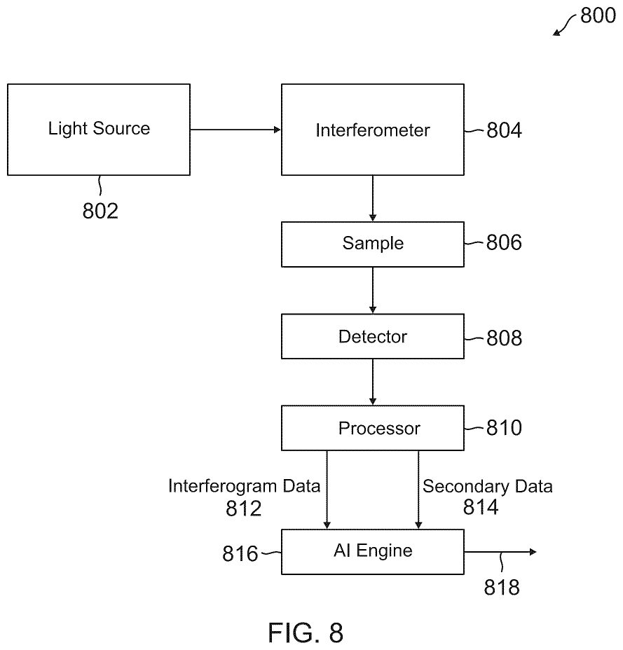

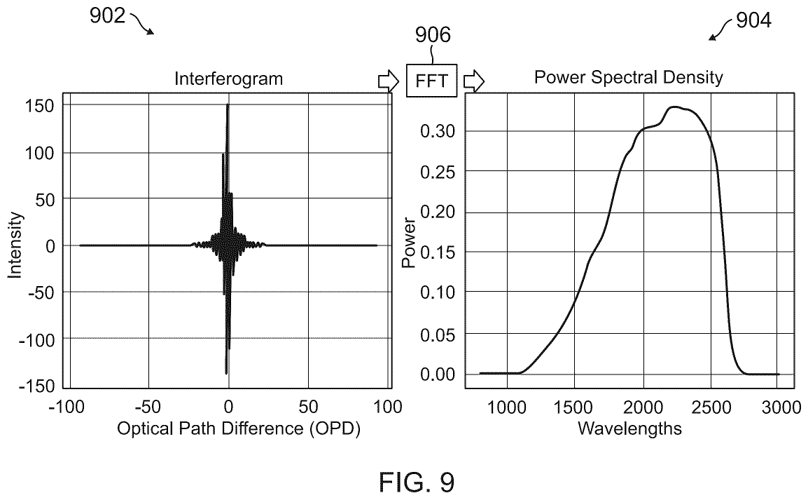

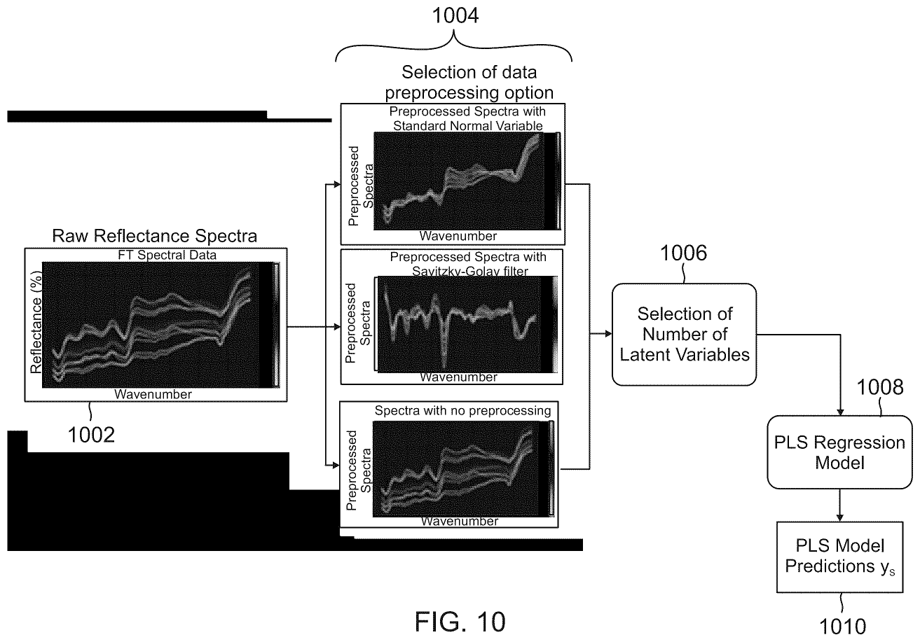

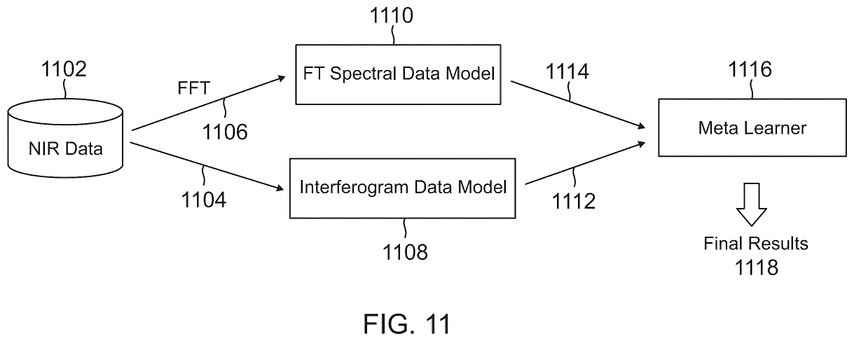

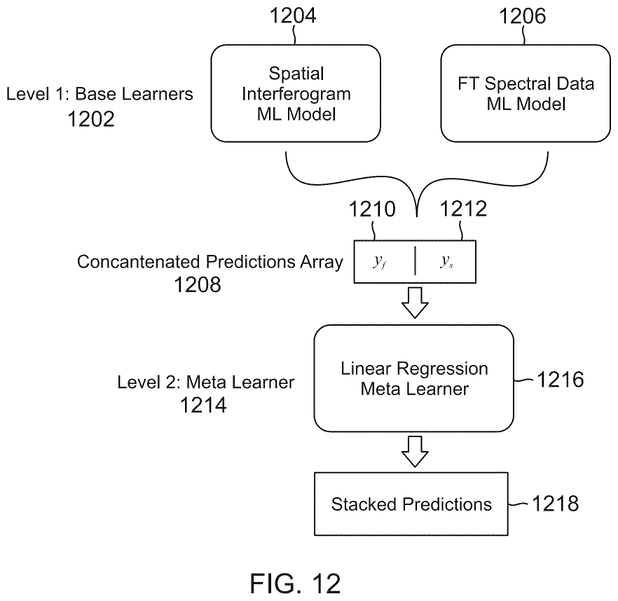

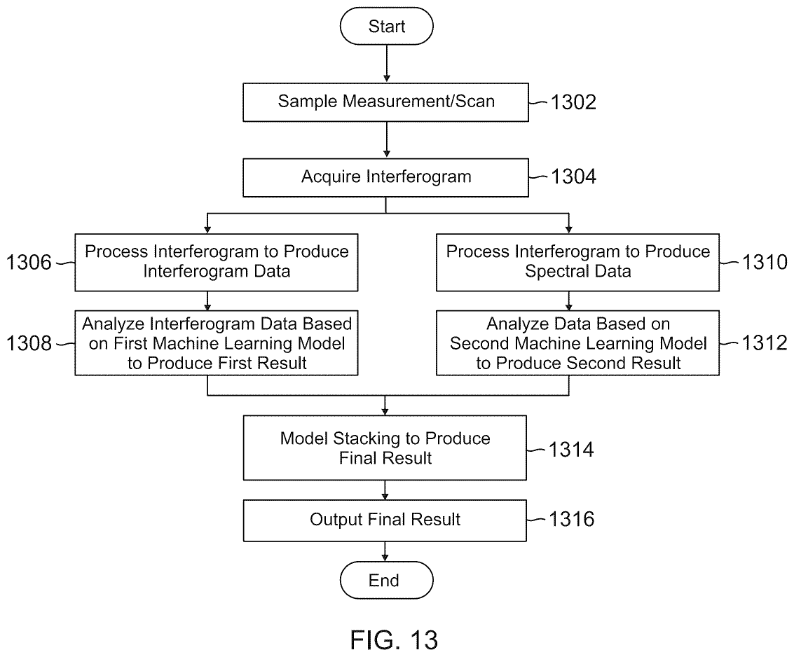

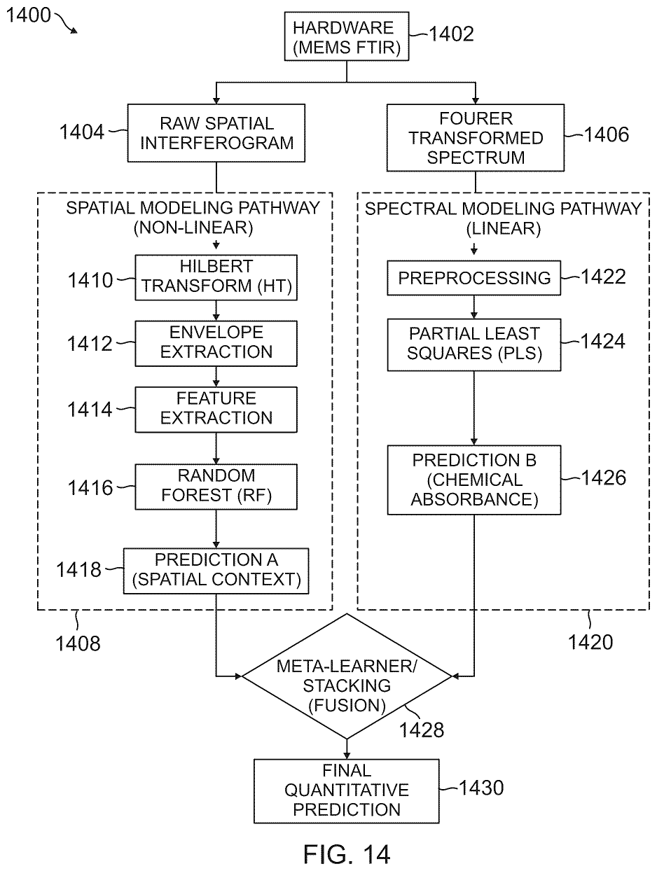

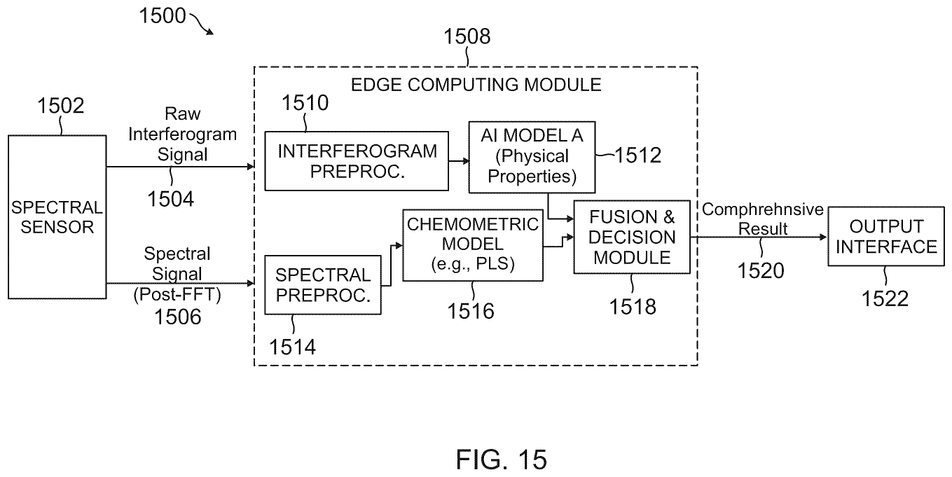

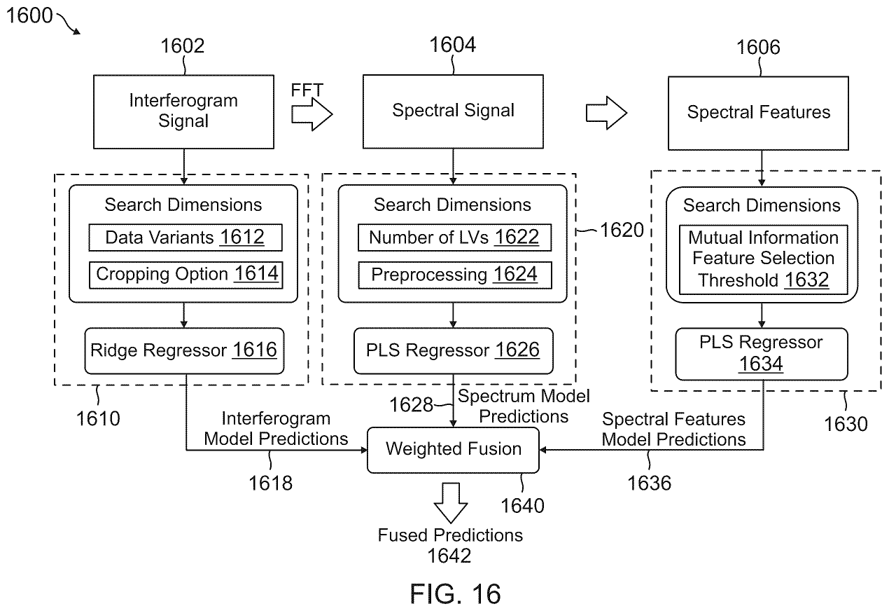

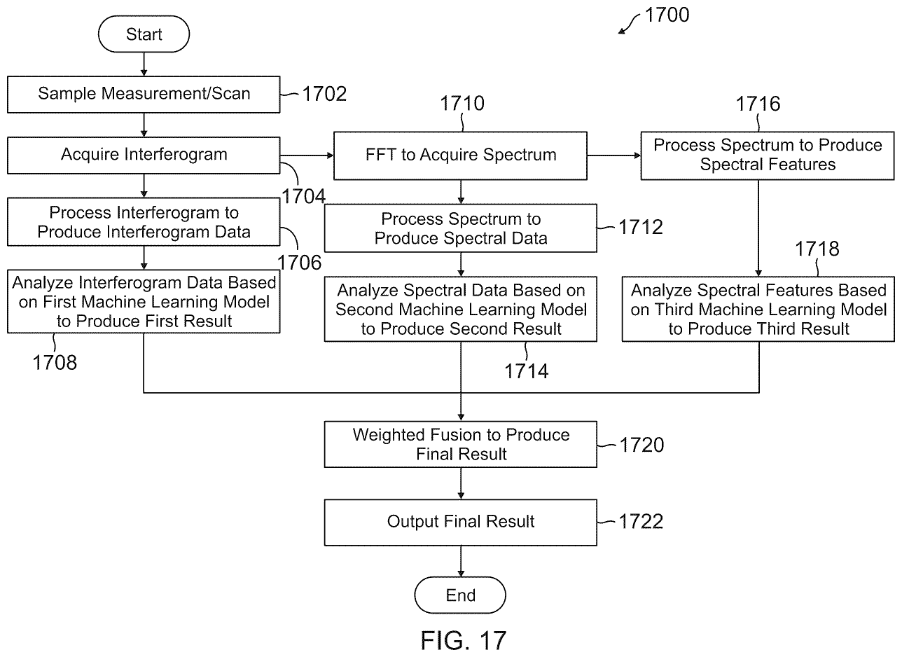

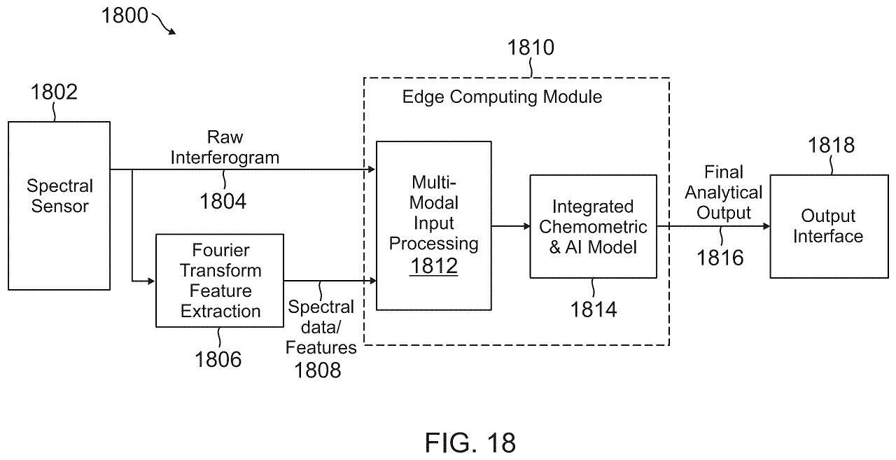

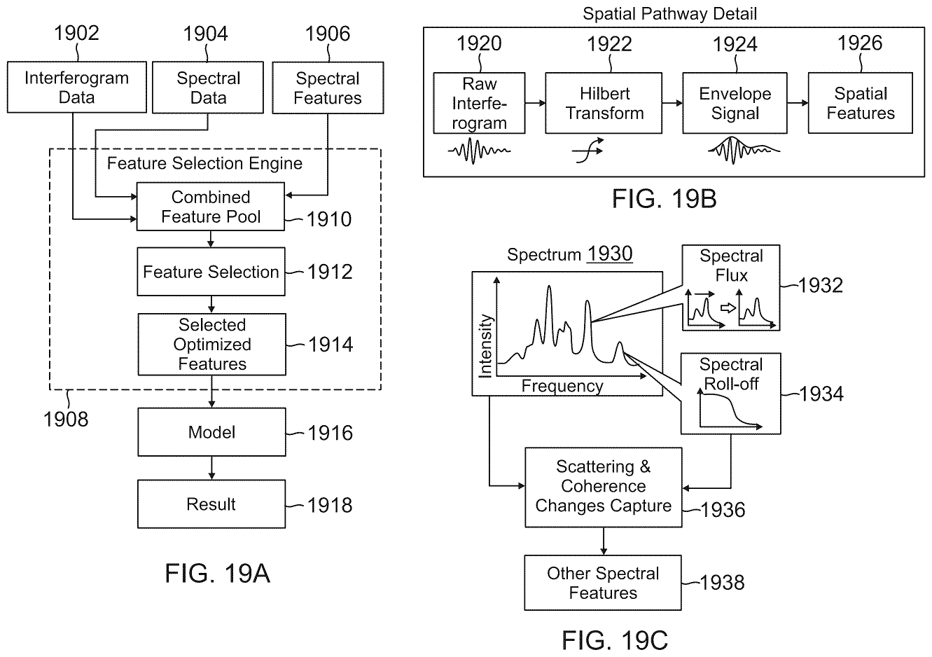

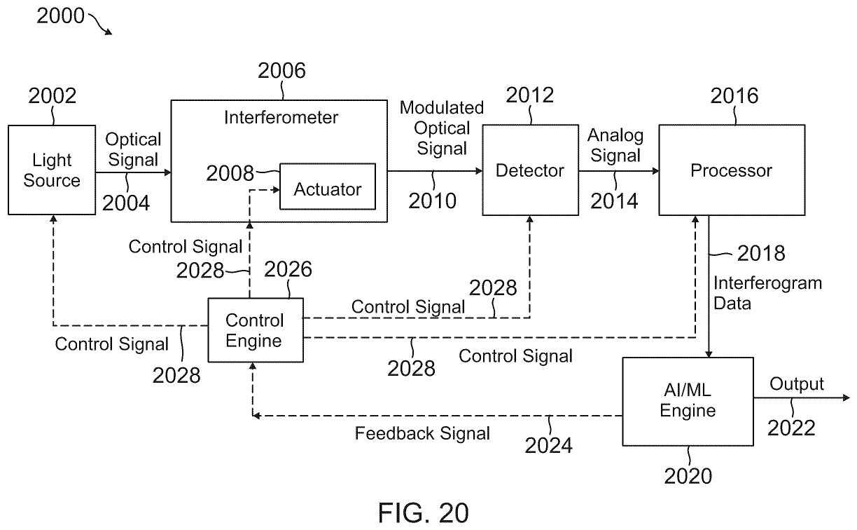

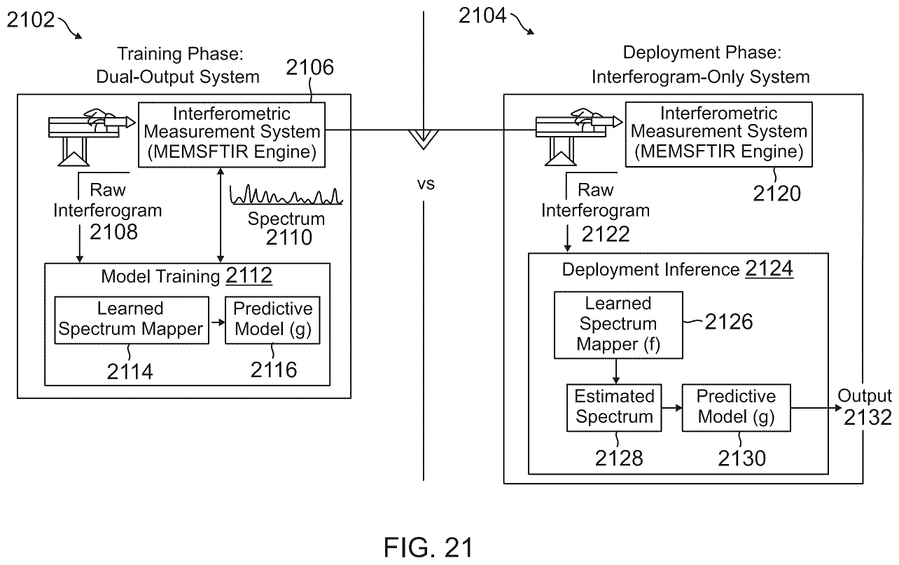

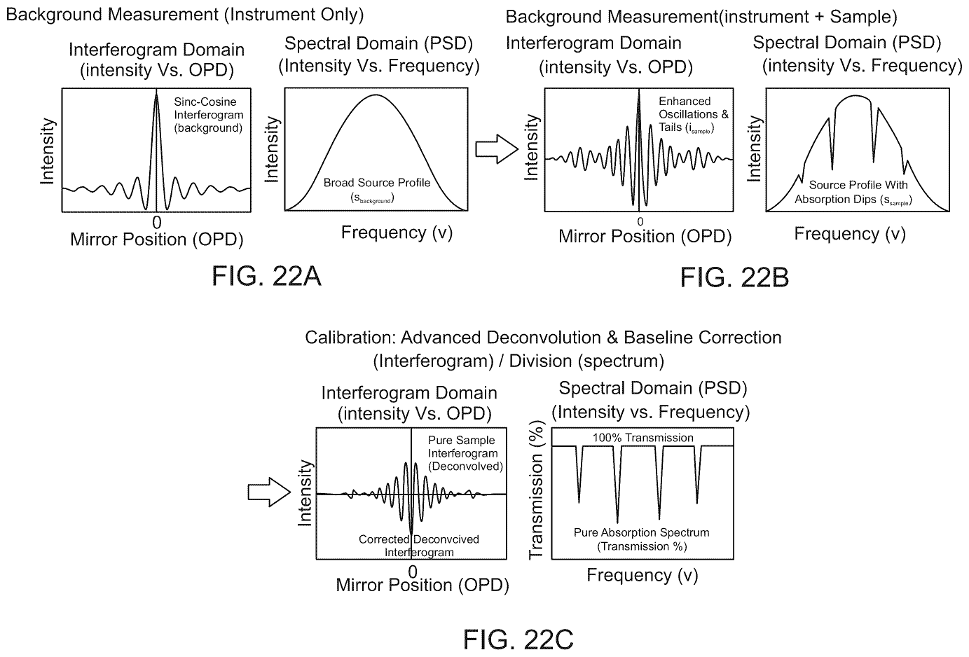

FIG. 2 illustrates an example of an apparatus configured for interferogram-based intelligent spectroscopy according to some aspects. The apparatus 200 includes a light source 202 configured to generate input light 204, an interferometer 206 configured to modulate the input light 204 to produce modulated light 208, and a detector 210 (e.g., a photodetector or array of photodetectors) configured to detect the modulated light 208 and produce an output signal 212 corresponding to an interferogram representing a measurement of a sample under test. The light source 202 may include, for example, one or more filament bulbs (e.g., incandescent bulbs) or light emitting diodes (LEDs) configured to direct the input light 204 (illumination light) towards the interferometer 206. Although not shown, the apparatus may further include illumination optics, such as one or more reflectors and/or lenses (not shown) configured to direct the input light 204 towards the interferometer 206. The interferometer 206 may correspond, for example, to a Michelson interferometer, a Fabry-Perot cavity, a spatial light modulator, or a birefringent device. For example, the light modulator may include a MEMS interference device, such as the MEMS based interferometer, as shown in FIG. 1. The MEMS interferometer enables generating a spectrum in millisecond time scale since the moving micromirror is driven by a MEMS actuator. In addition, although not shown, the apparatus may further include collection optics, such as one or more reflectors and/or lenses (not shown) configured to direct the modulated light 208 towards the detector 210.

The apparatus 200 further includes a processor 214 and an artificial intelligence (AI) engine 218. The processor 214 may include a single processing device or a plurality of processing devices. Such a processing device may be a microprocessor, microcontroller, digital signal processor, microcomputer, central processing unit, field programmable gate array, programmable logic device, logic circuitry, analog circuitry, digital circuitry, and/or any device that manipulates signals (analog and/or digital) based on hard coding of the circuitry and/or operational instructions.

The processor 214 is configured to process the interferogram 212 to produce a raw interferogram signal and to further produce interferogram data 216 based on the raw interferogram signal without application of a frequency domain (e.g., Fourier) transform to the raw interferogram signal. In some examples, the interferogram data 216 includes the raw interferogram signal itself without further processing. In other examples, the processor 214 can be configured to apply a smoothing filter to the raw interferogram signal to reduce noise and produce a smoothed interferogram signal. In this example, the interferogram data 216 can include the smoothed interferogram signal. In some examples, the processor 214 can be configured to compute an amplitude envelope signal from the raw interferogram signal and to output the amplitude envelope signal as the interferogram data 216. In some examples, the processor can be configured to extract or derive one or more spatial features from the amplitude envelope and to output the one or more spatial features as the interferogram data 216. For example, the spatial feature(s) can include one or more statistical features and/or one or more temporal features derived from the amplitude envelope signal.

In some examples, the processor 214 is configured to crop the raw interferogram signal to produce a cropped segment of the raw interferogram signal and to produce the interferogram data 216 based on the cropped segment of the raw interferogram signal. For example, the interferogram data 216 can include the cropped segment of the raw interferogram signal itself, a smoothed cropped segment of the raw interferogram signal, an amplitude envelope signal computed from the cropped segment of the raw interferogram signal, or one or more features derived from the amplitude envelope signal of the cropped segment of the raw interferogram signal.

The AI engine 218 is configured to receive the interferogram data 216 and to analyze the interferogram data based on one or more machine learning models to produce a result 220. For example, the result 220 may include a predictive, descriptive, or classification result based on the sample measurement obtained by the interferometer 206. In some examples, the AI engine 218 may apply one or more of a partial least squares (PLS) regression model, a random forest regression model, a deep learning regression model, a linear regression model, a stacked model (e.g., meta-learner model), or other suitable machine learning model to the interferogram data 216 to produce the result 220.

In some examples, the AI engine 218 can be configured to operate during a training phase and a deployment phase. In the training phase, the AI engine can be configured to utilize a plurality of interferogram data obtained over a plurality of optical path difference (OPD) ranges of the interferometer 206, whereas in the deployment phase, the AI engine can be configured to utilize interferogram data obtained over a single OPD range.

FIG. 3 is a diagram illustrating an example of a spatial interferogram data model construction workflow according to some aspects. The workflow 300 shown in FIG. 3 may be implemented, for example, by the processor 214 and AI engine 218 shown in FIG. 2. As an initial step in the workflow 300, an interferogram signal (e.g., a raw interferogram signal) is obtained based on an interferogram. In FIG. 3, the raw interferogram signal 302 is illustrated as a detector intensity as a function of a scan-domain variable (e.g., optical path difference (OPD) of the interferometer) during measurement of a sample. In some examples, optional preprocessing may be performed on the interferogram to obtain the raw interferogram signal.

From the raw interferogram signal 302, an envelope amplitude signal 304 can be computed. The envelope of a signal is a function that describes the maximum or minimum magnitude of the signal over a given time or spatial domain. It captures the overall trend of the amplitude variations, making it particularly useful for identifying significant features and trends within the signal while filtering out high-frequency noise. In the context of interferometry, the envelope 304 of an interferogram signal 302 can be calculated using the Hilbert transform, a mathematical operation that computes the analytic representation of a signal. The analytic representation includes both the original signal and its associated Hilbert transform, from which the envelope can be extracted.

The envelope E(t) of an interferogram signal I(t) can be calculated using the following equation:

$$E ( t ) = \sqrt{{I ( t )}^{2} + {H [ I ( t ) ]}^{2}} \qquad ( Equation 1 )$$

where I(t) represents the original interferogram signal and H[I(t)] denotes the Hilbert transform of the interferogram signal. The Hilbert transform of the interferogram signal I(t) is computed as follows:

$$H [ I ( t ) ] = \frac{1}{\prod } \cdot p \cdot v \cdot {\int }_{- ∞}^{∞} \frac{I ( τ )}{t - τ} d τ \qquad ( Equation 2 )$$

where p.v. denotes the Cauchy principal value of the integral.

The workflow 300 then proceeds to a feature extraction stage 306, in which key statistical and temporal features are derived from the interferograms' envelopes 304, constituting vital inputs for the development of a resilient predictive model. The identified features 306 may include, for example, one or more statistical features 308 and/or one or more temporal features 310. Statistical features 308 are computed based on the statistical characteristics inherent in the interferogram signals, while temporal features 310 capture the temporal dynamics of the signal. This detailed extraction process ensures that a machine learning model 312 is furnished with a comprehensive set of features 306, essential for building a predictive framework that accurately represents the complex spatial patterns within the interferogram data (e.g., the amplitude envelope 304).

For example, the statistical features 308 may include, but are not limited to, one or more of a mean value, log variance value, standard deviation value, skewness value, and/or Kurtosis value. The means value represents the average intensity of the interferogram signal and can be calculated, for example, as:

$$\tilde{x} = {\sum }_{i = 1}^{N} \frac{{x}_{i}}{N} \qquad ( Equation 3 )$$

The log variance value measures the spread or variability of the interferogram signal 302 on a logarithmic scale and can be calculated, for example, as:

$$logvariance = log [ {\sum }_{i = 1}^{N} \frac{{( {x}_{i} - \tilde{x} )}^{2}}{N} ] \qquad ( Equation 4 )$$

In addition, the standard deviation value quantifies the amount of variation or dispersion in the interferogram signal can be calculated, for example, as:

$$S T D = \sqrt{{\sum }_{i = 1}^{N} \frac{{( {x}_{i} - \tilde{x} )}^{2}}{N}} \qquad ( Equation 5 )$$

The skewness value measures the asymmetry of the interferogram signal's probability distribution and can be calculated, for example, as:

$$Skewness = {\sum }_{i = 1}^{N} \frac{{( {x}_{i} - \tilde{x} )}^{3}}{N} / {( {\sum }_{i = 1}^{N} \frac{{( {x}_{i} - \tilde{x} )}^{2}}{N} )}^{3 / 2} \qquad ( Equation 6 )$$

The Kurtosis value quantifies the tailedness of the interferogram signal's distribution and can be calculated, for example, as:

$$Kurtosis = {\sum }_{i = 1}^{N} \frac{{( {x}_{i} - \tilde{x} )}^{4}}{N} / {( {\sum }_{i = 1}^{N} \frac{{( {x}_{i} - \tilde{x} )}^{2}}{N} )}^{2} \qquad ( Equation 7 )$$

where xᵢ is the intensity value at each sample point, and N is the total number of points.

The temporal features 310 may include, but are not limited to, one or more of a temporal range, a mean crossing rate, a maximum temporal slope, a zero crossing rate, and/or a number of peaks. The temporal range represents the difference between the maximum and minimum values of the interferogram signal over time and can be calculated, for example, as:

$$TemporalRange = max ( x ) - min ( x ) \qquad ( Equation 8 )$$

The mean crossing rate counts the number of times the interferogram signal crosses its mean value and can be calculated, for example, as:

$$Mean Crossing Rate = Number of Mean Crossings / Total Time \qquad ( Equation 9 )$$

The maximum temporal slope measures the steepest slope between two adjacent points and can be calculated, for example, as:

$$Maximum Temporal Slope = max ( \frac{{x}_{i + 1} - {x}_{i}}{{t}_{i + 1} - t} ) \qquad ( Equation 10 )$$

The zero crossing rate counts the number of times the interferogram signal crosses the zero axis and can be calculated, for example, as:

$$Zero Crossing Rate = Number of Zero Crossings / Total Time \qquad ( Equation 11 )$$

The number of peaks represents the count of local maxima in the interferogram signal.

Following the feature extraction process, the extracted features 306 from one or more spatial interferograms can be utilized as inputs to a random forest regression model 312. The Random Forest Regressor 312 is a potent ensemble machine learning algorithm recognized for its ability to manage complexity and improve predictive accuracy by constructing multiple decision trees during training and aggregating their predictions to exploit coherence, fringe structure, and scan-domain signatures present in the interferogram(s). This step yields a prediction vector 314 for the interferogram model yr, which represents the interferogram data model output (or result 220 shown in FIG. 2).

FIG. 4 is a flowchart illustrating an example of a process for analyzing interferogram data based on machine learning according to some aspects. As described below, some or all illustrated features may be omitted in a particular implementation within the scope of the present disclosure, and some illustrated features may not be required for implementation of all examples. In some examples, the process may be performed by the apparatus 200, as described above and illustrated in FIG. 2, by a processor or processing system, or by any suitable means for carrying out the described functions.

At blocks 402 and 404, the process begins with performing a measurement or scan of a sample under test to acquire an interferogram. For example, the sample measurement may be performed by the interferometer 206 and detector 210 shown in FIG. 2 to capture spatial interference patterns reflecting variations in the sample's refractive index. At block 406, the process continues with processing the interferogram to produce a raw interferogram signal and to further produce interferogram data based on the raw interferogram signal without application of a frequency domain (e.g., Fourier) transform to the raw interferogram signal. In some examples, the interferogram data includes the raw interferogram signal (or a cropped segment thereof), a smoothed interferogram signal, an amplitude envelope signal computed from the raw interferogram signal (or cropped segment thereof), and/or one or more spatial features derived from the amplitude envelope signal.

At block 408, the process continues with analyzing the interferogram data based on a machine learning model to produce a result. For example, the machine learning model may include one or more of a partial least squares (PLS) regression model, a random forest regression model, a deep learning regression model, a linear regression model, a stacked model (e.g., meta-learner model), or other suitable machine learning model. At block 410, the process continues with outputting the result. For example, the result may include a predictive, descriptive, or classification result representing a composition of the sample or one or more other physical properties of the sample. For example, the result may represent real-time properties (e.g., concentration or other physical property), a quality assessment, or classification (e.g., material identity, pass/fail decision, anomaly detection, etc.) of the sample.

FIG. 5 illustrates another example of an apparatus configured for interferogram-based intelligent spectroscopy according to some aspects. The apparatus 500 includes a spectral sensor 502 configured to acquire an interferogram 504 from a sample and transmit the interferogram to an edge computing module 506. The spectral sensor 502 may include, for example, the light source 202, interferometer 206, and detector 210 shown in FIG. 2. The edge computing module 506 may be located, for example, at an edge of a network close to the spectral sensor 502 and can be configured to support artificial intelligence/machine learning (AI/ML) workloads, enabling local data processing to reduce cloud dependency.

In the example shown in FIG. 5, the edge computing module 506 can include a preprocessing device 508 (e.g., a microcontroller, microprocessor, etc.) configured to process the interferogram 504 to remove noise from the interferogram signal to produce a raw interferogram signal 518. In addition, the edge computing module 506 can include an interferogram feature extraction device 510 (e.g., a microcontroller, microprocessor, etc.) configured to extract physics-domain descriptors (features) 520, such as envelope characteristics, zero-crossing patterns, coherence signatures, and fringe-based features. For example, the features 520 can include one or more statistical features (e.g., mean value, log variance value, standard deviation value, skewness value, Kurtosis value, etc.) and/or one or more temporal features (e.g., temporal range, mean crossing rate, maximum temporal slope, zero crossing rate, number of peaks, etc.). The extracted features 520 can then be supplied to an AI engine 512, such as a lightweight convolutional or recurrent neural network, to generate a result 514 (e.g., a predicted concentration or classification of the sample). The result 514 can then be provided to an output interface 516 for downstream use. The configuration of the apparatus 500 shown in FIG. 5 enables interferogram-only intelligence at the edge without dependency on spectral-domain reconstruction.

FIGS. 6A-6C are diagrams illustrating examples of apparatuses including a MEMS interferometer integrated with an edge AI package according to some aspects. FIG. 6A illustrates a cross-sectional view of an apparatus 600a including an integrated MEMS optical engine die 602 and edge AI package 604 enclosed within a hermetically sealed housing 606. In the example shown in FIG. 6A, broadband infrared radiation 608 is coupled into the package 606 through a fiber-coupled optical input 610 and directed into the MEMS optical engine die 602 that implements an interferometric measurement device, including an interferometer 612 configured to generate a raw interferogram 614 as a function of optical path difference of the interferometer 6112. The interferometric signal is converted into an analog electrical signal and the raw analog interferogram 614 transmitted to the edge AI package 604, which may include, for example, an edge AI processor and integrated die (e.g., system-on-chip (SoC) module or application-specific circuit (ASC)). The edge AI package 604 can include an analog-to-digital converter (ADC) 616 and a digital signal processing and neural processing unit core (DSP/NPU core) 618. The DSP/NPU core 618 executes chemometric models and artificial intelligence models configured to operate on interferogram-domain signals (e.g., raw interferogram signal, smoothed interferogram signal, envelope signal, and/or features extracted from the envelop signal) to produce a result 620. The result 620 (e.g., predictive, descriptive, classification, or other type of result) can then be transmitted through a digital input/output interface 622 as a smart analytical output. The configuration shown in FIG. 6A enables on-chip interferometric sensing and interferogram-centric intelligence within a compact embedded package.

FIG. 6B illustrates a top view of an apparatus 600b that includes an embedded analytics printed circuit board (PCB) module 630 including a MEMS spectrometer head 632 that integrates optical components and a detector for interferometric measurement to produce an interferogram. The MEMS spectrometer head 632 is electrically coupled to a high-speed analog front-end (AFE) 634 that conditions the interferogram. The conditioned interferogram is then transmitted to an edge compute module 636 that includes, for example, a microcontroller unit and neural processing unit configured to execute integrated chemometric artificial intelligence models. The PCB 630 further includes, for example, non-volatile memory (e.g., RAM/Flash memory) 638, a power management integrated circuit 640, and a smart output interface 642 for transmitting analytical results. The embedded module shown in FIG. 6B enables real-time interferogram-centric analytics on a compact hardware platform.

FIG. 6C illustrates a physical optical pathway and sample interface for an apparatus 600c including an integrated MEMS Interferometer (e.g., MEMS FTIR) and edge AI package 650. An infrared emitter source 652 can be configured to generate broadband infrared radiation that is collimated by a lens assembly 654 and directed through a sampling interface 656, such as an attenuated total reflection (ATR) crystal, into a sample material 658. The transmitted or reflected radiation is collected by focusing optics 660 and directed into the integrated MEMS Interferometer and edge AI package 650, which performs on-chip interferometric measurement and interferogram-centric analytical inference to produce analytical result(s) 662. The resulting smart analytical output(s) 662 are transmitted to a host controller or display unit 664, enabling real-time property determination, quality assessment, or classification of the sample.

FIG. 7A is a diagram illustrating an example of a reduced-scan interferogram inference architecture based on selective optical path difference (OPD) windowing to produce cropped interferogram signals according to some aspects. FIG. 7B is a diagram illustrating examples of cropped interferogram signals according to some aspects. In the example shown in FIG. 7A, an interferometric measurement device 700, such as a MEMS FTIR spectrometer, acquires a raw interferogram 702 over a full OPD scan range from an illuminated sample. The raw interferogram 702 represents detector intensity as a function of optical path difference and encodes physical interference signatures arising from the light-matter interaction. Instead of utilizing the full OPD scan, a selective OPD windowing module 704 extracts a cropped segment 706 of the full OPD scan corresponding to a reduced OPD representation that includes only a subset of the interferogram samples. The cropped segment 706 is treated as the primary analytical input and is supplied to a reduced-scan interferogram inference pipeline.

The reduced-scan inference pipeline includes a preprocessing stage 708, followed by interferogram-domain feature extraction 710, and an inference model 712, such as a non-linear regression or classification model. The inference model (e.g., ML model) 712 generates an analytical output 714, including, for example, a prediction, classification, or property estimation, directly from the cropped segment 706 (e.g., reduced OPD representation) without requiring full interferogram reconstruction or spectral-domain transformation.

Various selective OPD windowing strategies may be employed by the selective OPD windowing module 704. For example, as illustrated in FIG. 7B, a truncated OPD window strategy 720 can be used, in which a reduced OPD span is extracted from the full interferogram to form the cropped segment 706. The resulting truncated OPD span (cropped segment 706) can enable shortened scan acquisition and reduced computational load. As another example, a center-burst-only OPD window strategy 722 can be used, in which only a localized OPD region surrounding zero path difference forms the cropped segment 706 used for inference, thereby exploiting the high-coherence, high-signal-to-noise region of the interferogram. As yet another example, an asymmetric OPD window strategy 724 can be used, in which an OPD region offset from zero path difference is selected as the cropped segment 706 to capture scan-direction-dependent behavior, actuator dynamics, and asymmetric coherence decay profiles. The reduced-scan interferogram inference architecture shown in FIGS. 7A and 7B enables analytical prediction from a shortened interferometric scan, while preserving the native physical encoding of coherence, fringe structure, and scan-domain signatures.

FIG. 8 is a diagram illustrating another example of an apparatus configured for interferogram-based intelligent spectroscopy according to some aspects. The apparatus 800 includes a light source 802 configured to generate input light, an interferometer 804 configured to modulate the input light to produce modulated light that may be directed to a sample 806 under test. The transmitted or reflected radiation from the sample 806 is directed towards a detector 808 (e.g., a photodetector or array of photodetectors) configured to produce an output signal corresponding to an interferogram representing a measurement of the sample 806. The light source 802 may include, for example, one or more filament bulbs (e.g., incandescent bulbs) or light emitting diodes (LEDs) configured to direct the input light (illumination light) towards the interferometer 804. Although not shown, the apparatus may further include illumination optics, such as one or more reflectors and/or lenses (not shown) configured to direct the input light towards the interferometer 804. The interferometer 804 may correspond, for example, to a Michelson interferometer, a Fabry-Perot cavity, a spatial light modulator, or a birefringent device. For example, the light modulator may include a MEMS interference device, such as the MEMS based interferometer, as shown in FIG. 1. In addition, although not shown, the apparatus may further include collection optics, such as one or more reflectors and/or lenses configured to direct the transmitted/reflected light from the sample 806 towards the detector 808.

The apparatus 800 further includes a processor 810 and an artificial intelligence (AI) engine 816. The processor 810 may include a single processing device or a plurality of processing devices. Such a processing device may be a microprocessor, microcontroller, digital signal processor, microcomputer, central processing unit, field programmable gate array, programmable logic device, logic circuitry, analog circuitry, digital circuitry, and/or any device that manipulates signals (analog and/or digital) based on hard coding of the circuitry and/or operational instructions.

The processor 810 is configured to process and subject the interferogram to physical encoding exploitation, which extracts information associated with coherence behavior, fringe structure, and scan-domain signatures inherent to the interferometric measurement to produce interferogram data 812. The interferogram data 812 is input to the AI engine 816 to generate, for example, a predictive or classification output 818 directly from the interferogram.

In some examples, as shown in FIG. 8, the interferogram data 812 may be combined with secondary data 814 (e.g., one or more secondary data representations) by the AI engine 816 to produce the result (output) 818. For example, the secondary data 814 can be derived from an interferogram obtained during a same measurement of the sample 806 or a different measurement of the sample 806 as that used to obtain the interferogram data 812. In some examples, the secondary data 814 can include spectral data associated with a spectrum (e.g., a power spectral density (PSD)) produced based on a Fourier transform of the interferogram. In some examples, the secondary data 814 can be combined with the interferogram data 812 through a fusion interface. For example, spatial domain features extracted from the interferogram data 812 and spectral domain features extracted from the secondary data 814 may be combined as input to a single ML model to generate the result 818.

As another example, the interferogram data 812 may be input a spatial-domain ML model and the secondary data 814 (e.g., spectral data) may be input to a spectral-domain ML model to generate respective outputs that can then be combined through a meta-learning or stacking fusion ML model to generate a final quantitative result 818. Such a dual-modality approach harnesses the advantages of fusing information from both spatial interferogram data and Fourier transform spectral data, which are then incorporated into a machine learning stacked architecture. This approach leverages the high-dimensional spectral information provided by the Fourier transform spectral data and the unique spatial patterns captured by interferograms, facilitating a comprehensive analysis that surpasses the capabilities of models based on a single data domain.

As yet another example, one or more spectral features may be extracted from the secondary data (e.g., spectral data) 814, and the spectral features may further be input to a spectral features ML model. A weighted fusion of the respective outputs of the spatial-domain ML model, the spectral-domain ML model, and the spectral features ML model may be then be obtained as the final result. This approach extends the concept of data fusion by introducing a weighted fusion model that integrates Fourier transform spectral data, spatial interferogram data, and derived spectral features. This framework assigns adaptive weights to each data modality based on its contribution to predictive accuracy, thereby optimizing the fusion process.

FIG. 9 is a diagram illustrating examples of an interferogram and corresponding spectrum according to some aspects. In the example shown in FIG. 9, an interferogram 902 represents a detector intensity as a function of a scan-domain variable (e.g., OPD) during measurement of a sample in a spatial domain. The interferogram 902 thus illustrates the spatial-domain interferogram as a function of optical path difference (OPD), showing the raw interference fringe structure. A spectrum 904 providing a power spectral density (PSD) of the interferogram 902 in a spectral domain may then be retrieved, for example, by applying a Fourier transform (e.g., Fast Fourier Transform (FFT)) 906 to the interferogram 902. The PSD 904 represents the power of the interferogram 902 as a function of the wavelengths measured by the interferometer (e.g., the wavelength range of the interferometer). For example, the interferogram 902 provides an autocorrelation waveform of the input optical spectrum, which when subjected to a Fourier transform yields the optical spectrum 904, which is the PSD as a function of the optical wavelength.

FIG. 10 is a diagram illustrating an example of a model construction process for spectral data according to some aspects. The model construction process initiates with the utilization of spectral data in the reflectance percentage format (e.g., raw reflectance spectra 1002). The raw reflectance data 1002 can then undergo a meticulous pipeline, beginning with an identification of a most effective preprocessing option 1004 of the raw reflectance data 1002 (e.g., spectra with no preprocessing, preprocessed spectra with Savitzky-Golay filter, preprocessed spectra with standard normal variable, etc.), and a selection of an optimal number of latent variables 1006. The processed spectral data (e.g., one of the selected preprocessed spectra 1004) is then introduced to a ML model 1008, such as a partial least squares (PLS) regression model. PLS, known for its efficacy in handling collinear and high-dimensional data, can be employed to establish a robust regression model that captures the intricate relationships between the spectral features and the target variable. This step yields a prediction vector 1010 for the interferogram model ys, which represents the spectral data model output. The spectral data model output 1010 can then be provided to the next step, which may be a stacked ML model (e.g., meta-learner) or a weighted fusion.

FIG. 11 is a diagram illustrating an example of model stacking according to some aspects. Model stacking is an ensemble technique merging statistical theory with machine learning, which operates through a two-layer structure. In this paradigm, near infra-red (NIR) data 1102, including interferogram (spatial) data 1104 and spectral data 1106 (e.g., obtained through a FFT of an interferogram), may be input to first-level models, encompassing an interferogram ML model 1108 and a FT spectral data ML model 1110, to introduce diversity to the ensemble by contributing unique information. The outcomes of these base-level models 1112 and 1114 are then fed into a meta-level ML model 1116 (e.g., a meta-learner). The meta-learner 1116 assumes a critical role, amalgamating predictions from varied base learners to craft a unified and robust final prediction/result 1118.

In some examples, the dual-modality fusion architecture shown in FIG. 11 thus enables an interferogram-domain model and a spectral-domain model to be trained in parallel from the same interferometric measurement. The outputs of the two models are combined using a stacking framework in which the meta-learner 1116 fuses the interferogram-based prediction and the spectrum-based prediction to generate a final analytical output 1118.

FIG. 12 is a diagram illustrating an example of a dual modality stacked model according to some aspects. In the example shown in FIG. 12, level-one base learners 1202, including a spatial interferogram ML model 1204 and a FT spectral data ML model 1206 each output respective results 1210 and 1212. The prediction 1210 and 1212 from the interferogram model 1204, denoted as yr, and the FT spectral data model 1206, denoted as ys, are then concatenated to form a concatenated predictions array 1208 for input to a level-two meta-learner 1214. The meta-learner 1214 may utilize, for example, a linear regression meta-learner ML model 1216 to produce a final result 1218 representing, for example, stacked predictions. For example, the concatenated input array 1208 can be utilized by the linear regressor 1216 to generate a final predictions vector 1218. The overarching model shown in FIG. 12 proves pivotal in harnessing the strengths and mitigating the weaknesses inherent in individual level-one base learners 1202. Functioning as the meta-learner 1214, the linear regressor 1216 plays a key role in combining information from both the interferogram and FT spectral data models 1204 and 1206, leading to the formulation of a unified and optimized final prediction vector 1218.

In some examples, the dual-modality stacked modeling workflow shown in FIG. 12 enables an interferogram-domain model and a spectral-domain model to be trained independently and their outputs combined by the meta-learner 1214. The stacked architecture leverages complementary information from both the spatial interferogram domain and the frequency-domain spectrum.

FIG. 13 is a flowchart illustrating an example of a process for implementing a dual modality stacked model according to some aspects. As described below, some or all illustrated features may be omitted in a particular implementation within the scope of the present disclosure, and some illustrated features may not be required for implementation of all examples. In some examples, the process may be performed by the apparatus 200, as described above and illustrated in FIG. 2, by the apparatus 800 shown in FIG. 8, by a processor or processing system, or by any suitable means for carrying out the described functions.

At blocks 1302 and 1304, the process begins with performing a measurement or scan of a sample under test to acquire an interferogram. For example, the sample measurement may be performed by the interferometer 206 and detector 210 shown in FIG. 2 or by the interferometer 804 and detector 808 shown in FIG. 8 to capture spatial interference patterns reflecting variations in the sample's refractive index.

At block 1306, the process continues with processing the interferogram to produce a raw interferogram signal and to further produce interferogram data based on the raw interferogram signal without application of a frequency domain (e.g., Fourier) transform to the raw interferogram signal. For example, the processor 214 shown in FIG. 2 or the processor 810 shown in FIG. 8 may be configured to produce the interferogram data. In some examples, the interferogram data includes the raw interferogram signal (or a cropped segment thereof), a smoothed interferogram signal, an amplitude envelope signal computed from the raw interferogram signal (or cropped segment thereof), one or more spatial features derived from the amplitude envelope signal, and/or other suitable interferogram-related data. At block 1308, the process continues with analyzing the interferogram data based on a first machine learning model to produce a first result. For example, the first machine learning model may include a random forest regression model. For example, the AI engine 218 shown in FIG. 2 or the AI engine 816 shown in FIG. 8 may be configured to analyze the interferogram data based on the first machine learning model.

At block 1310, the process further includes processing the interferogram to produce spectral data. For example, the process can include applying a frequency domain (e.g., Fourier) transform to the interferogram to obtain a spectrum and to further produce spectral data based on the spectrum. For example, the processor 214 shown in FIG. 2 or the processor 810 shown in FIG. 8 may be configured to produce the spectral data. In some examples, the spectral data includes raw reflectance spectra, preprocessed reflectance spectra, one or more spectral features derived from the spectrum, and/or other suitable spectrum-related data. At block 1312, the process continues with analyzing the spectral data based on a second machine learning model to produce a second result. For example, the second machine learning model may include a random PLS regression model including a number of latent variables. For example, the AI engine 218 shown in FIG. 2 or the AI engine 816 shown in FIG. 8 may be configured to analyze the spectral data based on the second machine learning model.

At block 1314, the process continues with performing model stacking of the first machine learning model and the second machine learning model to produce a final result. For example, the process can include concatenating the first result and the second result to form a concatenated input array. The process can then include inputting the concatenated input array to a meta-learner machine learning model to produce the final result. For example, the meta-learner machine learning model may include a linear regression model. For example, the AI engine 218 shown in FIG. 2 or the AI engine 816 shown in FIG. 8 may be configured to perform model stacking of the first and second machine learning models.

At block 1316, the process continues with outputting the result. For example, the result may include a predictive, descriptive, or classification result representing a composition of the sample or one or more other physical properties of the sample. For example, the result may represent real-time properties (e.g., concentration or other physical property), a quality assessment, or classification (e.g., material identity, pass/fail decision, anomaly detection, etc.) of the sample.

FIG. 14 is a diagram illustrating an example of a dual-domain analytical modeling architecture according to some aspects. The dual-domain analytical modeling architecture 1400 can be implemented using interferometric hardware, such as a MEMS FTIR system 1402. The interferometric hardware 1402 can be configured to generate a raw spatial interferogram 1404 and a corresponding Fourier-transformed spectrum (spectral data) 1406. The interferogram 1404 can be processed through a spatial-domain modeling pathway 1408 that includes a Hilbert transform 1410, envelope extraction 1412, and feature extraction 1414, followed by a non-linear machine learning model 1416, such as a random forest, to generate a spatial-context prediction 1418. In parallel, the spectral data 1406 is processed through a spectral-domain modeling pathway 1420 that includes preprocessing 1422 and partial least squares regression 1424 to generate a spectral prediction 1426 representing, for example, chemical absorbance. The outputs 1418 and 1426 of the spatial-domain and spectral-domain models are combined through a meta-learner or stacking fusion module 1428 to generate a final quantitative prediction 1430.

FIG. 15 is a diagram illustrating an example of an apparatus implementing a hybrid edge-computing architecture in which both interferogram-domain and spectral-domain signals are exploited for analytical inference according to some aspects. The apparatus 1500 includes a spectral sensor 1502 configured to generate both a raw interferogram signal 1504 and a spectral signal 1506 obtained via Fourier transformation. The spectral sensor 1502 may include, for example, the light source 202, interferometer 206, and detector 210 shown in FIG. 2. The spectral sensor 1502 is further configured to transmit the interferogram 1504 and spectral signal 1506 to an edge computing module 1508. The edge computing module 1508 may be located, for example, at an edge of a network close to the spectral sensor 1502 and can be configured to support artificial intelligence/machine learning (AI/ML) workloads, enabling local data processing to reduce cloud dependency.

In the example shown in FIG. 15, the edge computing module 1508 includes an interferogram preprocessing device 1510 (e.g., a microcontroller, microprocessor, etc.) configured to process the raw interferogram 1504 to remove noise from the interferogram signal to produce a raw interferogram signal. Although not shown, the edge computing module 1508 may further include an interferogram envelope or feature extraction device configured to extract an envelope signal and/or one or more features from the raw interferogram signal. The raw interferogram signal (or the envelope signal and/or extracted features) can then be supplied to a first artificial intelligence (ML) model 1512 configured to infer physical properties of the sample. In parallel, the spectral signal 1506 can be processed by a spectral preprocessing device 1514 (e.g., a microcontroller, microprocessor, etc.) within the edge computing module 1508 and supplied to a chemometric model 1516, such as partial least squares regression. The outputs of the interferogram-domain model 1512 and spectral-domain model 1516 can then be combined by a fusion and decision module 1518 (e.g., a meta-learner ML model) to generate a comprehensive analytical result 1520, which is transmitted to an output interface 1522. The architecture shown in FIG. 15 enables complementary exploitation of spatial interferogram physics and frequency-domain spectral chemistry.

FIG. 16 is a diagram illustrating an example of a weighted fusion framework according to some aspects. The weighted fusion framework 1600 combines the dual acquisition capability of MEMS FTIR of both an interferogram signal 1602 and a spectral signal 1604 (e.g., spectrum) produced by an interferometric system (e.g., a MEMS FTIR interferometer), not shown, to enhance the predictive performance of FT-NIRS (Near Infrared Spectroscopy) data by integrating a plurality of modeling frameworks (e.g., three or more modeling frameworks). In the example shown in FIG. 16, the weighted fusion framework 1600 integrates predictions from three base models operating on heterogeneous data representations, namely an interferogram-domain modeling framework 1610, a spectral-domain modeling framework 1620, and a spectral-feature modeling framework 1630. The weighted fusion framework 1600 combines respective outputs (e.g., outputs 1618, 1628, and 1636) of the base models 1610, 1620, and 1630 using an optimized weighting strategy employed by a weighted fusion module 1640 to generate a fused analytical prediction (e.g., fused prediction(s) 1642).

For example, the interferogram modeling framework 1610 leverages advanced interferogram data variants 1612 (e.g., as shown in FIG. 3), such as raw interferogram signals, envelopes, calculated features from envelopes (e.g., statistical and/or temporal features), and smoothed raw signals, along with data cropping optimizations 1614 (e.g., cropped or not cropped, as shown in FIGS. 7A and 7B) combined with an AI/ML model 1616, such as a Ridge regressor, to generate interferogram model predictions (e.g., a first result) 1618.

In parallel, a spectral modeling framework 1620 acquires Fourier transform spectral data (e.g., FFT of the interferogram signal 1602 to produce the spectral signal 1604) to capture the frequency domain characteristics of the sample. The spectral modeling framework 1620 combines optimization of preprocessing techniques 1624 and latent variables 1622 (e.g., as shown in FIG. 10) with an AI/ML model 1626, such as a Partial Least Squares (PLS) regressor, to enhance predictive performance and generate spectrum model predictions (e.g., a second result) 1618.

In addition, the weighted fusion framework 1600 further includes a spectral features modeling framework 1630, which utilizes spectral features 1606 extracted from the spectral signal 1604 combined with mutual information-based feature selection thresholds 1632 to refine predictions by prioritizing key spectral attributes. For example, a processor (e.g., processor 214 in FIG. 2 or processor 810 in FIG. 8) can be configured to extract one or more key spectral features 1606 from the spectral signal 1604. A mutual information-based feature selection process (e.g., using MI-based feature selection thresholds 1632) can then be implemented to select one or more of the extracted features. In some examples, the MI-based feature selection can be implemented by an AI engine (e.g., AI engine 218 shown in FIG. 2 or AI engine 816 shown in FIG. 8). The AI engine can further be configured to input the one or more extracted features to a ML model (e.g., a PLS regressor) 1634 to generate spectral features model predictions (e.g., a third result) 1636. This approach in NIRS modeling refines predictions by prioritizing attributes most relevant to the analytes of interest, adding a unique dimension to the modeling process.

Examples of spectral features can include, but are not limited to, a spectral centroid, spectral spread, spectral energy, spectral entropy, spectral roll-off, spectral flux, spectral flatness, spectral slope, spectral skewness, or spectral Kurtosis. In an example, let X(f) denote the spectral magnitude at frequency or wavenumber f. The spectral features can then be computed based on X(f). For example, the spectral centroid C represents the center of mass of the spectrum and is often interpreted as a measure of the signal's brightness. The spectral centroid (C) can thus be defined as:

$$C = \frac{{\sum }_{f} f \vert X ( f ) \vert}{{\sum }_{f} \vert X ( f ) \vert} \qquad ( Equation 12 )$$

The spectral centroid indicates where the bulk of the spectral energy is concentrated, with higher centroids corresponding to a shift toward higher frequencies.

The spectral spread S quantifies the dispersion of the spectral energy around the spectral centroid. It is the second central moment of the magnitude spectrum and can be computed as:

$$S = \sqrt{\frac{{\sum }_{f} {( f - c )}^{2} \vert X ( f ) \vert}{{\sum }_{f} \vert X ( f ) \vert}} \qquad ( Equation 13 )$$

A larger spread indicates a wider distribution of spectral energy.

Spectral energy E is a measure of the total energy contained within the spectrum, defined by the sum of the squared magnitudes:

$$E = {\sum }_{f} {\vert X ( f ) \vert}^{2} \qquad ( Equation 14 )$$

Spectral entropy H assesses the complexity or randomness of the spectral distribution. First, the power spectrum can be normalized to form a probability distribution:

$$P ( f ) = \frac{{\vert X ( f ) \vert}^{2}}{{\sum }_{f} {\vert X ( f ) \vert}^{2}} \qquad ( Equation 15 )$$

and the entropy can be calculated as:

$$H = - {\sum }_{f} P ( f ) log ( P ( f ) ) \qquad ( Equation 16 )$$

The spectral roll-off fᵣ is the frequency below which a predetermined percentage RRR (e.g., 85% or 90%) of the total spectral energy is contained. Formally, fᵣ is the solution to:

$${\sum }_{f = 0}^{{f}_{r}} {\vert X ( f ) \vert}^{2} = R \cdot {\sum }_{f} {\vert X ( f ) \vert}^{2} \qquad ( Equation 17 )$$

This feature provides a robust indicator of the distribution energy in the high-frequency range.

Spectral flux Φ measures the frame-to-frame change in the normalized spectral magnitude, capturing temporal variations in the spectrum. Given two consecutive spectral frames and, the spectral flux can be defined as:

$$Φ = {\sum }_{f} ( \frac{\vert {X}_{t} ( f ) \vert}{{\sum }_{f} \vert {X}_{t} ( f ) \vert} - \frac{\vert {X}_{t - 1} ( f ) \vert}{{\sum }_{f} \vert {X}_{t - 1} ( f ) \vert} ) \qquad ( Equation 18 )$$

Spectral flatness F quantifies the uniformity of the spectral distribution, distinguishing between noise-like and tone-like signals. This can be computed as the ratio of the geometric mean to the arithmetic mean of the power spectrum:

$$F = \frac{{( {\prod }_{f} {\vert X ( f ) \vert}^{2} )}^{1 / N}}{\frac{1}{N} {\sum }_{f} {\vert X ( f ) \vert}^{2}} \qquad ( Equation 19 )$$

where N is the number of frequency bins. A value of F close to 1 indicates a flat (noise-like) spectrum, while a lower value indicates a more tonal quality.

The spectral slope quantifies the rate at which the spectral magnitude decreases (or increases) with frequency. This is typically estimated by performing a linear regression on the log-magnitude spectrum:

$$log ( X ( f ) ) = af + b \qquad ( Equation 20 )$$

where the regression coefficient represents the spectral slope. A negative slope indicates a predominance of low-frequency content.

The spectral skewness Sₖ measures the asymmetry of the spectral distribution and can be given by:

$${S}_{k} = \frac{\frac{1}{N} {\sum }_{f} {( P ( f ) - u )}^{3}}{{( \frac{1}{N} {\sum }_{f} {( P ( f ) - u )}^{2} )}^{3 / 2}} \qquad ( Equation 21 )$$

where P(f)=|X(f)|² is the power spectrum and u is its mean.

The spectral kurtosis quantifies the “tailedness” or peakedness of the spectral distribution as follows:

$$K = \frac{\frac{1}{N} {\sum }_{f} {( P ( f ) - u )}^{4}}{{( \frac{1}{N} {\sum }_{f} {( P ( f ) - u )}^{2} )}^{2}} \qquad ( Equation 22 )$$

In order to refine the spectral features for predictive modeling, a mutual information (MI)-based feature selection strategy can be employed using, for example, the MI feature selection threshold(s) 1632. In this approach, the dependency between each extracted spectral feature and the target variable is quantified, thereby allowing those features that carry the most relevant information for prediction to be prioritized. Specifically, for each feature Xⱼ in the spectral feature matrix X∈R^{n×m} and for the target vector y∈Rⁿ, the mutual information can be defined as:

$$I ( {X}_{j} ; y ) = \int \int {p}_{{X}_{j , y}} ( x , y ) log ( \frac{{p}_{{X}_{j , y}} ( x , y )}{{p}_{{X}_{j}} ( x ) {p}_{y} ( y )} ) dxdy \qquad ( Equation 23 )$$

and is estimated using a regression-based estimator. The features are then ranked in descending order according to their MI scores.

To determine which features should be retained, the cumulative importance of the ranked features can be computed as:

$$CumulativeImportance = \frac{{\sum }_{j ∈ s o r t e d} I ( {X}_{j} ; y )}{{\sum }_{j = 1}^{m} I ( {X}_{j} ; y )} \qquad ( Equation 24 )$$

Rather than an arbitrary selection of the cumulative importance threshold T, a cross-validation procedure is used to optimize T. In this optimization, multiple candidate thresholds 1632 (e.g., values ranging from 50% to 100% cumulative importance) are evaluated based on the predictive performance of the subsequent regression model on validation data, and the threshold that yields the best cross-validated performance is selected. Only those features for which the cumulative importance does not exceed the optimized threshold T are retained, resulting in a reduced feature set X_{selected}.

For the spectral features modeling framework 1630, a partial least squares (PLS) regressor can be employed. Following the mutual information-based feature selection (e.g., using thresholds 1632), the selected features can be introduced into the PLS model 1634 to generate spectral features model predictions (e.g., a third result) 1636. In some examples, the optimal number of latent variables can be determined via cross-validation to maximize predictive performance. This integrated strategy in which the cumulative MI threshold is optimized and the selected features are utilized within the PLS regressor 1634 ensures that only the most informative spectral attributes are leveraged, thereby enhancing predictive accuracy while mitigating overfitting and multicollinearity.

The outputs (results) 1618, 1628, and 1636 of each of the modeling frameworks 1610, 1620, and 1630 can then be input to the weighted fusion module 1640 to apply respective weights to each of the outputs 1618, 1628, and 1636 to generate the final fused predictions (e.g., final result) 1642. By optimizing the respective weights of the individual models 1610, 1620, and 1630, the weighted fusion framework 1600 can generate an ensemble prediction 1642 that harnesses the complementary strengths of each modeling framework 1610, 1620, and 1630.

FIG. 17 is a flowchart illustrating an example of a process for implementing a dual modality stacked model according to some aspects. As described below, some or all illustrated features may be omitted in a particular implementation within the scope of the present disclosure, and some illustrated features may not be required for implementation of all examples. In some examples, the process may be performed by the apparatus 200, as described above and illustrated in FIG. 2, by the apparatus 800 shown in FIG. 8, by a processor or processing system, or by any suitable means for carrying out the described functions.

At blocks 1702 and 1704, the process begins with performing a measurement or scan of a sample under test to acquire an interferogram. For example, the sample measurement may be performed by the interferometer 206 and detector 210 shown in FIG. 2 or by the interferometer 804 and detector 808 shown in FIG. 8 to capture spatial interference patterns reflecting variations in the sample's refractive index.

At block 1706, the process continues with processing the interferogram to produce a raw interferogram signal and to further produce interferogram data based on the raw interferogram signal without application of a frequency domain (e.g., Fourier) transform to the raw interferogram signal. For example, the processor 214 shown in FIG. 2 or the processor 810 shown in FIG. 8 may be configured to produce the interferogram data. In some examples, the interferogram data includes the raw interferogram signal (or a cropped segment thereof), a smoothed interferogram signal, an amplitude envelope signal computed from the raw interferogram signal (or cropped segment thereof), one or more spatial features derived from the amplitude envelope signal, and/or other suitable interferogram-related data. At block 1708, the process continues with analyzing the interferogram data based on a first machine learning model to produce a first result. For example, the first machine learning model may include a random forest regression model or ridge regression model. For example, the AI engine 218 shown in FIG. 2 or the AI engine 816 shown in FIG. 8 may be configured to analyze the interferogram data based on the first machine learning model.

At block 1710, the process further includes processing the interferogram to acquire a spectrum. For example, the process can include applying a frequency domain (e.g., Fourier) transform to the interferogram to obtain a spectrum. At block 1712, the process continues with processing the spectrum to produce spectral data. For example, the processor 214 shown in FIG. 2 or the processor 810 shown in FIG. 8 may be configured to produce the spectral data. In some examples, the spectral data includes raw reflectance spectra, preprocessed reflectance spectra, and/or other suitable spectrum-related data. At block 1714, the process continues with analyzing the spectral data based on a second machine learning model to produce a second result. For example, the second machine learning model may include a random PLS regression model including a number of latent variables. For example, the AI engine 218 shown in FIG. 2 or the AI engine 816 shown in FIG. 8 may be configured to analyze the spectral data based on the second machine learning model.

At block 1716, the process further includes processing the spectrum (or spectral data) to produce one or more spectral features. For example, the one or more spectral features can include at least one of a spectral centroid, spectral spread, spectral energy, spectral entropy, spectral roll-off, spectral flux, spectral flatness, spectral slope, spectral skewness, or spectral Kurtosis. For example, the processor 214 shown in FIG. 2 or the processor 810 shown in FIG. 8 may be configured to produce the spectral features. In some examples, process further includes applying MI-based feature selection to the one or more spectral features to prioritize the one or more spectral features. In some examples, the process can include calculating a respective MI score for each of the one or more spectral features to obtain a rank of the one or more spectral features in descending order according to the respective MI score, calculating a cumulative importance of the one or more features, and retaining a reduced feature set of the one or more spectral features based on the cumulative importance, a cumulative importance threshold, and the rank. For example, the AI engine 218 shown in FIG. 2 or the AI engine 816 shown in FIG. 8 may be configured to apply MI-based feature selection to obtain the reduced feature set.

At block 1718, the process continues with analyzing the spectral features (e.g., reduced feature set) based on a third machine learning model to produce a third result. For example, the third machine learning model may include a PLS regression model including a number of latent variables. For example, the AI engine 218 shown in FIG. 2 or the AI engine 816 shown in FIG. 8 may be configured to analyze the spectral features based on the third machine learning model.

At block 1720, the process continues applying a weighted fusion to the first result, the second result and the third result to produce a final result. For example, the AI engine 218 shown in FIG. 2 or the AI engine 816 shown in FIG. 8 may be configured to produce the final result based on a weighted combination of the first result, the second result, and the third result. At block 1722, the process continues with outputting the final result. For example, the final result may include a predictive, descriptive, or classification result representing a composition of the sample or one or more other physical properties of the sample. For example, the result may represent real-time properties (e.g., concentration or other physical property), a quality assessment, or classification (e.g., material identity, pass/fail decision, anomaly detection, etc.) of the sample.

FIG. 18 is a diagram illustrating an example of an apparatus implementing an edge-computing architecture in which both interferogram-domain and spectral-domain signals/derived spectral features are integrated into a unified multi-modal intelligence pipeline according to some aspects. The apparatus 1800 includes a spectral sensor 1802 configured to generate a raw interferogram 1804. The spectral sensor 1802 may include, for example, the light source 202, interferometer 206, and detector 210 shown in FIG. 2. An on-chip Fourier transform and feature extraction module 1806 (e.g., a microprocessor or microcontroller on chip with the spectral sensor 1802) can then apply a Fourier transform to the raw interferogram 1804 to obtain a spectrum and to further extract one or more spectral features, such as peak intensities and spectral ratios, from the spectrum. In some examples, the Fourier transform and feature extraction module 1806 may further be configured to produce spectral data based on the spectrum.

The raw interferogram 1804 and the spectral data/features 1808 may then be processed by a multi-modal input processing device 1812 (e.g., a microcontroller, microprocessor, etc.) within an edge computing module 1810. However, in some examples, the spectral data may not be input to the edge computing module 1810. The edge computing module 1810 may be located, for example, at an edge of a network close to the spectral sensor 1802 and can be configured to support artificial intelligence/machine learning (AI/ML) workloads, enabling local data processing to reduce cloud dependency.

In some examples, the multi-modal input processing device 1812 can be configured to process the raw interferogram 1804 to remove noise from the interferogram signal to produce a raw interferogram signal. In some examples, the multi-modal input processing device may further be configured to extract an envelope signal and/or one or more features from the raw interferogram signal. The spectral data/features 1808 can further be processed by the multi-modal input processing device 1812 to, for example, apply a MI-based feature selection process to select a reduced set of features. The resulting processed inputs (interferogram 1804 and spectral data/features 1808) can then be supplied to an integrated chemometric and artificial intelligence model 1814, such as a deep learning model, which generates a final analytical output 1816. The result 1816 is transmitted to an output interface 1818. The configuration shown in FIG. 18 enables tightly coupled physics-domain and feature-domain intelligence on a compact embedded platform.

FIGS. 19A-19C are diagrams illustrating an example of a cross-domain feature generation and selection framework according to some aspects. The framework 1900 show in FIG. 19A integrates interferogram data 1902, spectral data 1904, and spectral features 1906. The interferogram data 1902 may include various interferogram data formats including, for example, raw interferogram data, envelope data, spatial features (e.g., statistical and/or temporal features), smoothed signal, and/or cropped signal representations. The spectral data 1904 may include various spectral data formats including, for example, various preprocessed spectral data formats. The spectral features 1906 may include, for example, spectral centroid, spectral spread, spectral energy, spectral entropy, spectral roll-off, spectral flux, spectral flatness, spectral slope, spectral skewness, or spectral Kurtosis.

A feature selection engine 1908 can be configured to construct a combined feature pool 1910 from the interferogram data 1902, spectral data 1904, and spectral features 1906 and perform feature selection 1912 on the combined feature pool 1910 to select one or more optimized features 1914. In some examples, the feature selection engine 1908 can apply mutual information optimization to select the optimized features to maximize dependency while minimizing redundancy. The resulting optimized feature set 1914 can then be used by a predictive (ML) model 1916 (e.g., a single ML model or stacked model) to generate a result 1918. For example, the result 1918 can correspond to a robust concentration value.

FIG. 19B illustrates a spatial pathway for obtaining the interferogram data 1902. For example, a raw interferogram 1920 can be transformed using a Hilbert transform 1922 to produce an envelope signal 1924, enabling extraction of coherence and fringe-based physical features (e.g., spatial features) 1926. For example, the spatial features 1926 may include one or more statistical features and/or one or more temporal features.

FIG. 19C illustrates a spectral features pathway for obtaining the spectral features 1906. The spectral features 1906 can include, for example, a spectral flux 1932, spectral roll-off 1934, and/or one or other spectral features 1938 that can generated, for example, based on a spectrum (e.g., a Fourier transform of an interferogram) 1930. For example, the spectrum 1930 may be processed by a scattering and coherence changes capture module 1936 configured to capture various additional spectral features 1938 associated with physical sample properties from the spectrum 1930.

FIG. 20 is a diagram illustrating another example of an apparatus configured for interferogram-based intelligent spectroscopy according to some aspects. The apparatus 2000 shown in FIG. 20 is configured to implement a closed-loop interferometric intelligence architecture in which analytical inference generated from a raw interferogram is used to dynamically control interferometric acquisition parameters and illumination conditions.

The apparatus 2000 include an illumination source (light source) 2002 configured to emit radiation (light or optical signal 2004) toward a sample through an interferometric measurement device (e.g., interferometer 2006). The interferometer 2006 may be, for example, a MEMS FTIR spectrometer on-chip with an actuator 2008 and control circuits (not shown). The interferometer 2006 is configured to modulate the input light 2004 to produce a modulated optical signal 2010 (e.g., that may be transmitted/reflected through a sample under test) directed towards a detector 2012. The detector 2012 is configured to produce an output analog signal representative of a raw interferogram as a function of optical path difference of the interferometer 2006. The raw interferogram is processed by a processor 2016 to produce interferogram data 2018, which is supplied to an AI/ML interferogram inference engine 2020. The AI/ML engine 2020 generates an analytical output 2022, which may include, for example, a regression output (e.g., concentration, physical property) or a classification output (e.g., material identity, pass/fail decision, anomaly detection).

The analytical output is further provided as a feedback signal 2024 to an adaptive control engine 2026 that includes one or more control circuits configured to dynamically adjust acquisition parameters of the interferometer 2006 (e.g., actuator 2008), detector 2012, processor 2016, and/or illumination source 2002 via one or more respective control signals 2028. For example, the control engine 2026 may control the scan length, scan velocity, OPD sampling density, scan termination timing, MEMS actuator trajectory, illumination power, modulation, or integration time. In some examples, the control engine 2026 can be configured to terminate a scan early once a confidence threshold is achieved. In other examples, the control engine 2026 can be configured to perform adaptive scan refinement based on predicted material properties. In still other examples, the control engine 2026 can be configured to adjust illumination conditions based on predicted optical density, scattering behavior, or sample reflectance. The system thereby forms an autonomous interferometric sensing platform that actively optimizes its own measurement process in real time.

FIG. 21 is a diagram that illustrates a dual-mode interferometric intelligence architecture according to some aspects. The architecture includes a training phase 2102 using a dual-output interferometric measurement system and a deployment phase 2104 using an interferogram-only measurement system or operating mode. In the training phase 2102, an interferometric measurement system 2106, such as a MEMS FTIR engine, acquires a raw interferogram 2108 and generates a corresponding spectral representation (spectrum) 2110 from the same measurement. The paired interferogram-spectrum data are input to a model training pipeline 2112 including a learned spectrum-generation model 2114 and a predictive model 2116. The learned spectrum-generation model 2114 is trained to map the interferogram 2108 to a corresponding spectral-domain representation 2110, while the predictive model 2116 is trained using the paired interferogram and spectral data (2108/2110). In some examples, the model training pipeline 2112 can be trained with multiple OPD ranges in the training phase 2102.

In the deployment phase 2104, an interferometric measurement system 2120 operates in an interferogram-only mode or includes a system that outputs only the raw interferogram 2122 in order to reduce acquisition time, power consumption, and computational complexity. The raw interferogram 2122 based on a single OPD range is provided to a deployment inference pipeline 2124 including a learned spectrum-generation model 2126, which generates an estimated spectral representation (estimated spectrum) 2128. The estimated spectral representation 2128 is then provided to a predictive model 2130 to generate an analytical inference output 2132, such as a regression value, classification result, or quality metric. The deployment phase architecture 2104 thereby achieves spectral-domain predictive performance without requiring spectral reconstruction to be produced by the interferometric instrument during operation, enabling high-speed, low-power, and low-latency analytical inference on embedded and edge-deployed platforms.

Such a dual-mode architecture in which training is performed using interferometric systems configured to output both interferogram and spectral representations, while deployment may use an interferogram-only system or operating mode can result in reduced power consumption, faster acquisition, and lower computational complexity. A learned mapping generating a corresponding spectral-domain representation from the interferogram during deployment enables spectral-domain predictive performance without requiring spectral reconstruction by the instrument.

FIGS. 22A-22C are diagrams illustrating background calibration of an interferometric measurement according to some aspects. Initially, as shown in FIG. 22A, a background measurement may be obtained without a sample in the light path of the interferometric system (e.g., light source-interferometer-detector). In some examples, the light source can be a black body radiator, outputting a broad, smooth curve of energy. In the interferogram domain, a broad spectrum corresponds to a very sharp, narrow interferogram center burst. As shown in FIG. 22B, a sample may then be placed in the light path and an additional measurement may be obtained. The sample absorbs specific frequencies, creating dips in the spectrum. Thus, in the spectral domain, the same broad source profile is visible, but it now has sharp notches cut out of it where the sample absorbed the light. In the interferogram domain, because sharp features have been introduced in the spectrum, the interferogram changes. The sharp spectral features correspond to long-lasting oscillations in the interferogram. Thus, the “wings” of the interferogram may stay active for longer.

Turning now to FIG. 22C, background calibration can be performed in the interferogram domain to remove the spectral response of the spectrometer. In some examples, background calibration can be performed in the spectral domain by taking the Fourier transform of both measured interferograms (with and without the sample) and then dividing them (e.g., dividing the power spectral density of the sample measurement by the power spectral density of the background measurement). In other examples, the background interferogram can be deconvoluted from the sample interferogram, which is equivalent to dividing the power spectral density of the sample measurement by the power spectral density of the background measurement. For example, because the measured sample interferogram is the convolution of the background interferogram and the actual sample's response, deconvolution can be performed to isolate the sample.

The present disclosure as described herein is directed to an interferogram-centric sensing, modeling, and data-fusion architecture in which an interferogram acquired from an interferometric measurement is treated as a primary and independent analytical data modality, rather than as a transient intermediate intended solely for conversion into a spectral representation. In accordance with the disclosure, the interferogram is acquired as a function of optical path difference or an equivalent scan-domain variable and is utilized directly in its native acquisition format. The interferogram is processed and exploited in its raw and unfiltered form, without requiring apodization, smoothing, denoising, windowing, frequency-domain transformation, or spectral reconstruction as a prerequisite for core operation. The interferogram is therefore preserved as a direct physical encoding of the light-matter interaction, retaining coherence behavior, spatial interference structure, and scan-domain signatures that may be partially lost or distorted after transformation into the frequency domain. The raw interferogram may therefore serve as a standalone predictive, descriptive, or classification signal for determining one or more properties of a sample, generating quality metrics, or producing derived representations, without requiring the presence of spectral-domain data.

In some examples, the interferogram-first pathway may be combined or fused with one or more secondary data representations derived from the same measurement or from a related (e.g., prior or subsequent) measurement. Such secondary representations are not limited to any specific data format and may include, but are not limited to, Fourier spectra, power spectral density, wavelet domains, engineered feature vectors, statistical descriptors, embeddings, image-like encodings, or auxiliary sensor data. In such configurations, the interferogram remains the anchor modality, while the secondary representation functions as a complementary modality whose contribution may be fixed, adaptive, or learned. Accordingly, the present disclosure establishes a universal and extensible data architecture in which raw physical interference data forms the foundational layer of intelligence, enabling direct exploitation of interferometric measurements prior to any domain-specific transformation and supporting flexible fusion with arbitrary secondary representations.

The disclosed interferogram-centric and dual-modality modeling architecture yields reduced dependent on wavelength calibration, improved robustness to instrumental and environmental perturbations, material predictive improvements over single-modality baselines, enhanced stability in MEMS FTIR deployment contexts, and practical edge intelligence deployment. In addition, a reduced-scan and selective OPD inference architecture can allow for ultra-fast acquisition, low-power operation, and robust inference without requiring full interferometric scans or spectral reconstruction. Moreover, as the interferogram alone represents a sufficient physical encoding of the light-matter interaction for analytical inference, a simplified sensing pipeline with reduced computational overhead can be achieved.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-22 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-3, 5-12 14-16, and 18-22 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus, comprising:
an interferometer configured to receive input light and to modulate the input light to produce modulated light;
a detector configured to receive the modulated light and to produce an output signal based on the modulated light;
a processor configured to process the output signal to produce a raw interferogram signal and further to produce interferogram data based on the raw interferogram signal, wherein the interferogram data is produced without application of a frequency domain transform to the raw interferogram signal; and
an artificial intelligence engine configured to analyze the interferogram data based on a machine learning model to produce a result.

2. The apparatus of claim 1, wherein the interferogram data comprises the raw interferogram signal.

3. The apparatus of claim 1, wherein the processor is configured to apply a smoothing filter to the raw interferogram signal to produce a smoothed interferogram signal and the interferogram data comprises the smoothed interferogram signal.

4. The apparatus of claim 1, wherein the processor is configured to compute an amplitude envelope signal of the raw interferogram signal and wherein the interferogram data is based on the amplitude envelope signal.

5. The apparatus of claim 4, wherein the interferogram data comprises the amplitude envelope signal.

6. The apparatus of claim 4, wherein the processor is configured to derive at least one feature from the amplitude envelope signal and the interferogram data comprises the at least one feature.

7. The apparatus of claim 6, wherein the at least one feature comprises at least one statistical feature, wherein the at least one statistical feature comprises one or more of a mean value, log variance value, standard deviation value, skewness value, or Kurtosis value.

8. The apparatus of claim 6, wherein the at least one feature comprises at least one temporal feature, wherein the at least one temporal feature comprises one or more of a temporal range, mean crossing rate, maximum temporal slope, zero crossing rate, or number of peaks.

9. The apparatus of claim 6, wherein the machine learning model comprises a random forest regression model applied to the at least one feature to produce the result.

10. The apparatus of claim 1, wherein the processor is configured to crop the raw interferogram signal to produce a cropped segment of the raw interferogram signal, wherein the interferogram data is based on the cropped segment of the raw interferogram signal.

11. The apparatus of claim 1, wherein the processor is further configured to produce secondary data derived from an interferogram obtained during a same measurement or a different measurement as that used to obtain the raw interferogram signal, wherein the artificial intelligence engine is further configured to combine the secondary data with the interferogram data to produce the result.

12. The apparatus of claim 11, wherein the artificial intelligence engine is configured to combine the secondary data with the interferogram data during at least a training phase of the artificial intelligence engine.

13. The apparatus of claim 12, wherein the training phase utilizes a plurality of interferogram data and a plurality of secondary data obtained over a plurality of optical path difference (OPD) ranges of the interferometer, and wherein a deployment phase of the artificial intelligence engine utilizes only the interferogram data obtained over a single OPD range of the interferometer.

14. The apparatus of claim 11, wherein the machine learning model comprises a first machine learning model configured to analyze the interferogram data to produce a first result, wherein the secondary data comprises spectral data associated with a spectrum produced based on a Fourier transform of the interferogram, and wherein the artificial intelligence engine is further configured to analyze the spectral data based on a second machine learning model to produce a second result.

15. The apparatus of claim 14, wherein the processor is configured to apply the Fourier transform to the interferogram to produce raw reflectance spectra and to further process the raw reflectance spectra to produce the spectral data.

16. The apparatus of claim 14, wherein the second machine learning model comprises a partial least squares (PLS) regression model comprising a number of latent variables.

17. The apparatus of claim 14, wherein the artificial intelligence engine is further configured to perform model stacking of the first machine learning model and the second machine learning model to produce a final result.

18. The apparatus of claim 17, wherein the artificial intelligence engine is configured to concatenate the first result and the second result to form a concatenated input array, wherein the artificial intelligence engine is further configured to analyze the concatenated input array based on a meta-learner machine learning model to produce the final result.

19. The apparatus of claim 18, wherein the meta-learner machine learning model comprises a linear regression model.

20. The apparatus of claim 14, wherein the processor is further configured to extract one or more spectral features from the spectrum, wherein the artificial intelligence engine is further configured to analyze the one or more spectral features based on a third machine learning model to produce a third result, wherein the artificial intelligence engine is further configured to produce a final result based on a weighted combination of the first result, the second result, and the third result.

21. The apparatus of claim 20, wherein the one or more spectral features comprises at least one of a spectral centroid, spectral spread, spectral energy, spectral entropy, spectral roll-off, spectral flux, spectral flatness, spectral slope, spectral skewness, or spectral Kurtosis.

22. The apparatus of claim 20, wherein the artificial intelligence engine is further configured to apply mutual information (MI)-based feature selection to the one or more spectral features to prioritize the one or more spectral features for the third machine learning model.

23. The apparatus of claim 22, wherein the artificial intelligence engine is configured to:
calculate a respective MI score for each of the one or more spectral features and to obtain a rank of the one or more spectral features in descending order according to the respective MI score,
calculate a cumulative importance of the one or more spectral features,
retain a reduced feature set of the one or more spectral features based on the cumulative importance, a cumulative importance threshold, and the rank, and
analyze the reduced feature set using the third machine learning model to produce the third result.

24. The apparatus of claim 20, wherein the third machine learning model comprises a partial least squares (PLS) regression model.

25. The apparatus of claim 1, wherein:
the processor is further configured to produce spectral data associated with a spectrum produced based on a Fourier transform of an interferogram obtained during a same measurement or a different measurement as that used to obtain the raw interferogram signal and to extract one or more spectral features from the spectrum,
the processor is further configured to produce a pool of features comprising the interferogram data, the spectral data, and the one or more spectral features and to select one or more selected features from the pool of features, and
the artificial intelligence engine is further configured to analyze the one or more selected features based on the machine learning model to produce the result.

26. The apparatus of claim 1, wherein the output signal comprises a sample interferogram representing a detector intensity as a function of a scan-domain variable during measurement of a sample, and wherein the result is associated with a property of the sample.

27. The apparatus of claim 26, wherein the scan-domain variable comprises an optical path difference over a single optical path difference range.

28. The apparatus of claim 26, wherein the processor is further configured to deconvolute a background interferogram from the sample interferogram to produce the raw interferogram signal.

29. The apparatus of claim 1, wherein the artificial intelligence engine is further configured to generate a feedback signal based on at least the interferogram data, and further comprising:
a controller configured to control, based on the feedback signal, one or more of the interferometer, the detector, the processor, or a light source configured to generate the input light.

30. The apparatus of claim 1, wherein the artificial intelligence engine is configured to utilize a plurality of interferogram data obtained over a plurality of optical path difference (OPD) ranges of the interferometer during a training phase, and to utilize the interferogram data obtained over a single OPD range of the interferometer during a deployment phase.
